(19) United States
(12) Patent Application Publication
(10) Pub. No.: US 2018/0124680 A1
(43) Pub. Date: May 3, 2018

(54) SIGNAL BARRING OF DELAY TOLERANT ACCESS

(71) Applicant: Qualcomm Incorporated, San Diego, CA (US)

(72) Inventors: Mungal Singh Dhanda, Slough (GB); Masato Kitazoe, Hachiouji-shi (JP)

(21) Appl. No.: 15/726,887

(22) Filed: Oct. 6, 2017

Related U.S. Application Data
(60) Provisional application No. 62/413,948, filed on Oct. 27, 2016.

(51) Int. Cl. H04W 48/06; H04W 56/00; H04W 28/02

(52) U.S. Cl. CPC H04W 48/06; H04L 67/12; H04W 28/0236; H04W 56/001

(57) ABSTRACT

Methods, systems, and devices for wireless communication are described. The method includes transmitting a first barring bitmap associated with a first configuration of user equipments (UEs) based at least in part on a decision to implement access class barring (ACB), determining a radio access network (RAN) provides network service to UEs of a second configuration different from the first configuration, transmitting a delay tolerant barring indicator associated with the second configuration based at least in part on the decision to implement ACB and determining that the RAN provides network services to UEs of a second configuration.

### CROSS REFERENCES

The present Application for Patent claims priority to U.S. Provisional Patent Application No. 62/413,948 by Dhanda, et al., entitled “Signal Barring of Delay Tolerant Access,” filed Oct. 27, 2016, assigned to the assignee hereof.

### BACKGROUND

The following relates generally to wireless communication, and more specifically to signal barring of delay tolerant access.

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include code division multiple access (CDMA) systems, time division multiple access (TDMA) systems, frequency division multiple access (FDMA) systems, and orthogonal frequency division multiple access (OFDMA) systems, (e.g., a Long Term Evolution (LTE) system, or a New Radio (NR) system). A wireless multiple-access communications system may include a number of base stations or access network nodes, each simultaneously supporting communication for multiple communication devices, which may be otherwise known as user equipment (UE).

A base station may provide multiple UEs access to certain network services such as transmission of voice and data communications. In some cases, a base station may restrict a UE's access to such network services. As one example, a base station may implement a restriction procedure to allow access to a first portion of UEs while restricting access of a second portion of UEs. In some cases, the configuration of the base station may result in the first portion of UEs being restricted whether or not the restriction procedure is implemented.

### SUMMARY

The described techniques relate to improved methods, systems, devices, or apparatuses that support barring of delay tolerant access. Generally, the described techniques provide for efficient ways to signal barring of delay tolerant access in relation to a user equipment (UE) making a request to establish a connection with a radio access network (RAN). Specifically, a RAN may add an indicator to a message sent to a UE to signal whether an access barring bitmap applies to the UE. When the indicator indicates the UE is to apply the bitmap, the UE may analyze the bitmap to determine whether the UE is permitted to make a request to establish a connection with the RAN. In some cases, the RAN may send an additional access barring bitmap to the UEs to circumvent certain UEs being barred even when the RAN is not implementing barring procedures.

A method of wireless communication is described. The method may include transmitting a first barring bitmap associated with a first configuration of UEs based at least in part on a decision to implement ACB, determining a RAN provides network service to UEs of a second configuration, the second configuration being different from the first configuration, and transmitting a delay tolerant barring indicator associated with the second configuration based at least in part on the decision to implement ACB and determining that the RAN provides network services to UEs of a second configuration.

An apparatus for wireless communication is described. The apparatus may include means for transmitting a first barring bitmap associated with a first configuration of UEs based at least in part on a decision to implement ACB, means for determining a RAN provides network service to UEs of a second configuration, the second configuration being different from the first configuration, and means for transmitting a delay tolerant barring indicator associated with the second configuration based at least in part on the decision to implement ACB and determining that the RAN provides network services to UEs of a second configuration.

Another apparatus for wireless communication is described. The apparatus may include a processor, memory in electronic communication with the processor, and instructions stored in the memory. The instructions may be operable to cause the processor to transmit a first barring bitmap associated with a first configuration of UEs based at least in part on a decision to implement ACB, determine a RAN provides network service to UEs of a second configuration, the second configuration being different from the first configuration, and transmit a delay tolerant barring indicator associated with the second configuration based at least in part on the decision to implement ACB and determining that the RAN provides network services to UEs of a second configuration.

A non-transitory computer readable medium for wireless communication is described. The non-transitory computer-readable medium may include instructions operable to cause a processor to transmit a first barring bitmap associated with a first configuration of UEs based at least in part on a decision to implement ACB, determine a RAN provides network service to UEs of a second configuration, the second configuration being different from the first configuration, and transmit a delay tolerant barring indicator associated with the second configuration based at least in part on the decision to implement ACB and determining that the RAN provides network services to UEs of a second configuration.

In some examples of the method, apparatus, and non-transitory computer-readable medium described above, the delay tolerant barring indicator indicates whether to apply the first barring bitmap or a second barring bitmap to UEs configured with a second configuration.

Some examples of the method, apparatus, and non-transitory computer-readable medium described above may further include processes, features, means, or instructions for determining a proportion of the UEs of the second configuration, in relation to a total number of UEs that may be provided network service by the RAN, satisfies a proportion threshold.

Some examples of the method, apparatus, and non-transitory computer-readable medium described above may further include processes, features, means, or instructions for transmitting a second barring bitmap associated with the second configuration based at least in part on the determining.

Some examples of the method, apparatus, and non-transitory computer-readable medium described above may further include processes, features, means, or instructions for determining a proportion of the UEs of the second configuration, in relation to a total number of UEs that may be provided network service by the RAN, fails to satisfy a proportion threshold.

Some examples of the method, apparatus, and non-transitory computer-readable medium described above may further include processes, features, means, or instructions for bypassing a transmission of a second barring bitmap associated with the second configuration.

Some examples of the method, apparatus, and non-transitory computer-readable medium described above may further include processes, features, means, or instructions for setting a bit of the delay tolerant indicator UEs configured with the second configuration to apply the first barring bitmap based at least in part on determining the proportion of the UEs of the second configuration fails to satisfy the proportion threshold.

In some examples of the method, apparatus, and non-transitory computer-readable medium described above, the decision to implement ACB may be based at least in part on network usage information associated with the RAN satisfies a congestion threshold.

In some examples of the method, apparatus, and non-transitory computer-readable medium described above, the second barring bitmap associated with the second configuration indicates delay tolerant access classes of UEs may be barred from accessing the RAN.

In some examples of the method, apparatus, and non-transitory computer-readable medium described above, the network services provided by the RAN comprise a narrow band internet of things (NB-IoT) network service.

In some examples of the method, apparatus, and non-transitory computer-readable medium described above, the delay tolerant barring indicator comprises a system information block (SIB).

A method of wireless communication is described. The method may include receiving, from a RAN, a first barring bitmap associated with a first configuration and receiving, from the RAN, a delay tolerant barring indicator associated with a second configuration, the delay tolerant barring indicator triggering a decision as to whether the UE supports delay tolerant barring.

An apparatus for wireless communication is described. The apparatus may include means for receiving, from a RAN, a first barring bitmap associated with a first configuration and means for receiving, from the RAN, a delay tolerant barring indicator associated with a second configuration, the delay tolerant barring indicator triggering a decision as to whether the UE supports delay tolerant barring.

Another apparatus for wireless communication is described. The apparatus may include a processor, memory in electronic communication with the processor, and instructions stored in the memory. The instructions may be operable to cause the processor to receive, from a RAN, a first barring bitmap associated with a first configuration and receive, from the RAN, a delay tolerant barring indicator associated with a second configuration, the delay tolerant barring indicator triggering a decision as to whether the UE supports delay tolerant barring.

A non-transitory computer readable medium for wireless communication is described. The non-transitory computer-readable medium may include instructions operable to cause a processor to receive, from a RAN, a first barring bitmap associated with a first configuration and receive, from the RAN, a delay tolerant barring indicator associated with a second configuration, the delay tolerant barring indicator triggering a decision as to whether the UE supports delay tolerant barring.

Some examples of the method, apparatus, and non-transitory computer-readable medium described above may further include processes, features, means, or instructions for receiving a second barring bitmap associated with the second configuration.

Some examples of the method, apparatus, and non-transitory computer-readable medium described above may further include processes, features, means, or instructions for applying the second barring bitmap with respect to accessing the RAN based at least in part on the decision that the UE supports delay tolerant barring.

Some examples of the method, apparatus, and non-transitory computer-readable medium described above may further include processes, features, means, or instructions for identifying a bit of the delay tolerant barring indicator may be enabled, the bit relating to applying the first barring bitmap. Some examples of the method, apparatus, and non-transitory computer-readable medium described above may further include processes, features, means, or instructions for applying the first barring bitmap with respect to accessing the RAN based at least in part on the identified bit of the delay tolerant barring indicator being enabled.

Some examples of the method, apparatus, and non-transitory computer-readable medium described above may further include processes, features, means, or instructions for applying the first barring bitmap to the UE with respect to accessing the RAN.

In some examples of the method, apparatus, and non-transitory computer-readable medium described above, the delay tolerant barring indicator comprises a system information block (SIB).

Some examples of the method, apparatus, and non-transitory computer-readable medium described above may further include processes, features, means, or instructions for applying the first barring bitmap with respect to accessing the RAN based at least in part on the decision that the UE does not support delay tolerant barring.

In some examples of the method, apparatus, and non-transitory computer-readable medium described above, the UE may be configured with at least one of the first configuration or the second configuration.

### BRIEF DESCRIPTION OF THE DRAWINGS

FIG. 1 illustrates an example of a system for wireless communication that supports signal barring of delay tolerant access in accordance with aspects of the present disclosure.

FIG. 2 illustrates an example of a wireless communications system that supports signal barring of delay tolerant access in accordance with aspects of the present disclosure.

FIG. 3 illustrates an example of a process flow that supports signal barring of delay tolerant access in accordance with aspects of the present disclosure.

FIG. 4 illustrates an example of a process flow that supports signal barring of delay tolerant access in accordance with aspects of the present disclosure.

FIG. 5 illustrates an example of a process flow that supports signal barring of delay tolerant access in accordance with aspects of the present disclosure.

FIG. 6 illustrates an example of a method that supports signal barring of delay tolerant access in accordance with aspects of the present disclosure.

FIGS. 7 through 9 show block diagrams of a device that supports signal barring of delay tolerant access in accordance with aspects of the present disclosure.

FIG. 10 illustrates a block diagram of a system including a base station that supports signal barring of delay tolerant access in accordance with aspects of the present disclosure.

FIGS. 11 through 13 show block diagrams of a device that supports signal barring of delay tolerant access in accordance with aspects of the present disclosure.

FIG. 14 illustrates a block diagram of a system including a UE that supports signal barring of delay tolerant access in accordance with aspects of the present disclosure.

FIGS. 15 through 20 illustrate methods for signal barring of delay tolerant access in accordance with aspects of the present disclosure.

### DETAILED DESCRIPTION

Low-power Wide-Area Network (LPWAN) is a type of wireless telecommunication network that may be designed to enable long range communications at a low bit rate. LPWAN may include wireless wide area network technology configured for interconnecting devices with low-bandwidth connectivity, with emphasis on range and power efficiency.

NarrowBand Internet of Things (NB-IoT) is a LPWAN radio technology standard developed to enable a wide range of devices and services to be connected using cellular telecommunications bands. NB-IoT is a narrowband radio technology designed for the Internet of Things (IoT) and Mobile IoT (MIoT) technologies. In some cases, the infrastructure of NB-IoT may be directed towards indoor coverage, low cost, long battery life, and enabling network access to a large number of connected devices. The NB-IoT network may either be deployed “in-band” in spectrum allocated to Long Term Evolution (LTE), utilizing resource blocks within a normal LTE carrier or in the unused resource blocks within a LTE carrier's guard-band, implemented in a “standalone” configuration for deployments in dedicated spectrum, in re-farming of Global System for Mobile (GSM) spectrum, and the like.

In one embodiment, an NB-IoT system may be configured for delay tolerant access. As one example, the delay tolerant access establishment cause may be used when a user equipment (UE) has been configured for low priority Non-Access Stratum (NAS) signaling. In some cases, a delay tolerant access cause may be used to inform an eNodeB that a UE intends to make a Radio Resource Control (RRC) connection for low priority NAS signaling. In some cases, low priority NAS signaling may provide a mechanism for congestion control, such as dropping low priority signaling prior to higher priority signaling during periods of congestion.

In some cases, disasters can cause extraordinary service demand on a communication network, resulting in service outages that reduce network capacity to serve the surging demand. Access Class Barring (ACB) enables services supporting disaster response management to perform with minimal degradation during such events. In order to provide adequate service to special users like first responders, ACB implements priority treatment mechanisms. For example, ACB may drop certain voice and data traffic in response to extreme overloads. In one embodiment, each UE in a network may be assigned an access class. Certain users, such as police, firefighters, paramedics, and other first responders, may be assigned to a first access class (AC) range on a network, while non-first responders may be assigned to a second AC range on the network. As one example, AC 0 to 9 may be assigned to general users, AC 10 may be assigned to emergency calls (e.g., 911 calls), while AC 11 to 15 may be assigned for special or high priority users such as first responders. As explained above, when demand for bandwidth on the network exceeds supply, voice and data communications may be drop at random. During an emergency, this could result in communications of a first responder being dropped. Accordingly, ACB may monitor bandwidth usage to determine when demand for bandwidth satisfies a congestion threshold. Upon determining the congestion threshold is satisfied, ACB may provide a controlled method of dropping calls based on assigned ACs, barring communications for one or more ACs while not barring one or more other ACs. For example, during a time of network congestion, ACB may drop one or more ACs in the second AC range to provide the freed-up bandwidth to the voice and data communications of UEs in the first AC range, resulting in first responders being provided with minimal degradation of service during such events.

As one example, an eNodeB may broadcast barring information to multiple UEs. The barring information may include an allocation of ACs indicating the AC for at least some of the multiple UEs. The UE may initiate a service request in the NAS layer. In response to the service request, the UE may check the barring information received from the eNodeB. The barring information may indicate whether the UE is currently barred from establishing a connection with the eNodeB. For example, the barring information may indicate the UE is barred during a time specified in the barring information. If barred, the UE may indicate the service request has failed and wait to make another request during the specified time. If not barred, then the UE may send an RRC connection request to the eNodeB. In some cases, the RRC connection request may include an indication that the UE is configured for delay tolerant access. During times of network congestion and/or overload, the eNodeB may determine whether to allow the UE to establish the requested connection based on the AC allocated to the UE. When the allocated AC indicates the UE has a high priority, then the eNodeB may allow the UE to establish the requested connection. When the allocated AC indicates the UE is to be barred, then the eNodeB may respond with an RRC connection rejection. In some cases, the RRC connection rejection may indicate an extended wait time. The specified extended wait time may indicate how long before the UE is allowed to make another RRC connection request. For example, the extended wait time may indicate that the UE is to wait 30 minutes before making another RRC connection request. Accordingly, the UE waits for the extended wait time before requesting service again. In some cases, the eNodeB may reject RRC connection requests initiated by UEs not configured for low-access priority or delay tolerant access, rejecting all RRC connection requests that are for non-emergency and non-high-priority mobile originated services.

In some cases, NB-IoT devices may support access barring. However, conventional NB-IoT eNodeBs may not differentiate through conventional access barring between connection requests for delay tolerant data transfer and connection requests for non-delay tolerant data transfer. In some embodiments, the configuration of a RAN, including eNodeBs, base stations, etc., may result in the RAN barring UEs not supporting access barring of NAS signaling low priority whether or not barring procedures are activated due to network congestion. Accordingly, certain UEs such as those not configured with NAS signaling low priority may be barred from accessing the RAN even when the RAN is not sufficiently congested or overloaded to handle connection requests from UEs not configured with NAS signaling low priority.

In one embodiment, a flag may be added to a message to signal whether an access barring bitmap and/or category only applies to UEs making connections requests with the delayTolerantAccess establishment cause. Such a flag may be added to common and per public land mobile network (PLMN). Additionally, or alternatively, an additional access barring bitmap may be sent to the UEs to avoid barring certain UEs accessing network with an establishment cause other than delayTolerantAccess whether or not the RAN is implementing barring procedures. The present systems and methods may include hardware, firmware, and/or software configured to control access barring of delay tolerant access with efficient signaling. In some embodiments, the present systems and methods may provide flexibility to control access for both UEs that are configured with NAS signaling low priority and those UEs that are not configured with NAS signaling low priority.

Aspects of the disclosure are initially described in the context of a wireless communications system. Aspects of the disclosure are further illustrated by and described with reference to apparatus diagrams, system diagrams, and flowcharts that relate to signal barring of delay tolerant access.

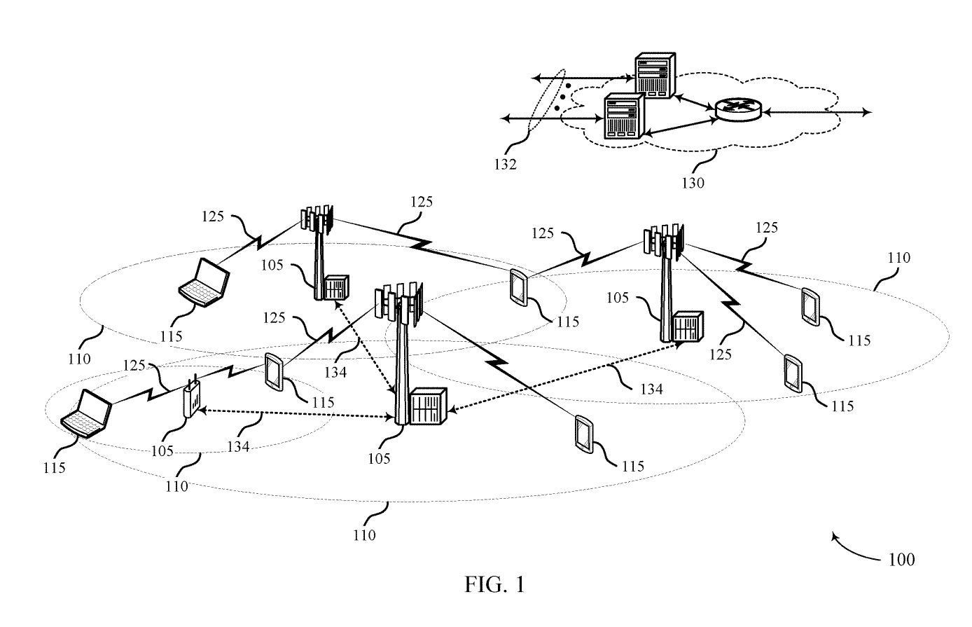

FIG. 1 illustrates an example of a wireless communications system 100 in accordance with various aspects of the present disclosure. The wireless communications system 100 includes base stations 105, UEs 115, and a core network 130. In some examples, the wireless communications system 100 may be a LTE (or LTE-Advanced) network, or a New Radio (NR) network. In some cases, wireless communications system 100 may support enhanced broadband communications, ultra-reliable (i.e., mission critical) communications, low latency communications, and communications with low-cost and low-complexity devices. The wireless communications system 100 enables efficient methods to signal barring of delay tolerant access.

Base stations 105 may wirelessly communicate with UEs 115 via one or more base station antennas. Each base station 105 may provide communication coverage for a respective geographic coverage area 110. Communication links 125 shown in wireless communications system 100 may include uplink (UL) transmissions from a UE 115 to a base station 105, or downlink (DL) transmissions, from a base station 105 to a UE 115. Control information and data may be multiplexed on an uplink channel or downlink according to various techniques. Control information and data may be multiplexed on a downlink channel, for example, using time division multiplexing (TDM) techniques, frequency division multiplexing (FDM) techniques, or hybrid TDM-FDM techniques. In some examples, the control information transmitted during a TTI of a downlink channel may be distributed between different control regions in a cascaded manner (e.g., between a common control region and one or more UE-specific control regions).

UEs 115 may be dispersed throughout the wireless communications system 100, and each UE 115 may be stationary or mobile. A UE 115 may also be referred to as a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. A UE 115 may also be a cellular phone, a personal digital assistant (PDA), a wireless modem, a wireless communication device, a handheld device, a tablet computer, a laptop computer, a cordless phone, a personal electronic device, a handheld device, a personal computer, a wireless local loop (WLL) station, an Internet of things (IoT) device, an Internet of Everything (IoE) device, a machine type communication (MTC) device, an appliance, an automobile, or the like.

In some cases, a UE 115 may also be able to communicate directly with other UEs (e.g., using a peer-to-peer (P2P) or device-to-device (D2D) protocol). One or more of a group of UEs 115 utilizing D2D communications may be within the coverage area 110 of a cell. Other UEs 115 in such a group may be outside the coverage area 110 of a cell, or otherwise unable to receive transmissions from a base station 105. In some cases, groups of UEs 115 communicating via D2D communications may utilize a one-to-many (1:M) system in which each UE 115 transmits to every other UE 115 in the group. In some cases, a base station 105 facilitates the scheduling of resources for D2D communications. In other cases, D2D communications are carried out independent of a base station 105.

Some UEs 115, such as MTC or IoT devices, may be low cost or low complexity devices, and may provide for automated communication between machines, i.e., Machine-to-Machine (M2M) communication. M2M or MTC may refer to data communication technologies that allow devices to communicate with one another or a base station without human intervention. For example, M2M or MTC may refer to communications from devices that integrate sensors or meters to measure or capture information and relay that information to a central server or application program that can make use of the information or present the information to humans interacting with the program or application. Some UEs 115 may be designed to collect information or enable automated behavior of machines. Examples of applications for MTC devices include smart metering, inventory monitoring, water level monitoring, equipment monitoring, healthcare monitoring, wildlife monitoring, weather and geological event monitoring, fleet management and tracking, remote security sensing, physical access control, and transaction-based business charging.

In some cases, an MTC device may operate using half-duplex (one-way) communications at a reduced peak rate. MTC devices may also be configured to enter a power saving “deep sleep” mode when not engaging in active communications. In some cases, MTC or IoT devices may be designed to support mission critical functions and wireless communications system may be configured to provide ultra-reliable communications for these functions.

Base stations 105 may communicate with the core network 130 and with one another. For example, base stations 105 may interface with the core network 130 through backhaul links 132 (e.g., S1, etc.). Base stations 105 may communicate with one another over backhaul links 134 (e.g., X2, etc.) either directly or indirectly (e.g., through core network 130). Base stations 105 may perform radio configuration and scheduling for communication with UEs 115, or may operate under the control of a base station controller (not shown). In some examples, base stations 105 may be macro cells, small cells, hot spots, or the like. Base stations 105 may also be referred to as eNodeBs (eNBs) 105.

A base station 105 may be connected by an S1 interface to the core network 130. The core network may be an evolved packet core (EPC), which may include at least one MME, at least one S-GW, and at least one P-GW. The MME may be the control node that processes the signaling between the UE 115 and the EPC. All user IP packets may be transferred through the S-GW, which itself may be connected to the P-GW. The P-GW may provide IP address allocation as well as other functions. The P-GW may be connected to the network operators IP services. The operators IP services may include the Internet, the Intranet, an IP Multimedia Subsystem (IMS), and a Packet-Switched (PS) Streaming Service (PSS).

The core network 130 may provide user authentication, access authorization, tracking, Internet Protocol (IP) connectivity, and other access, routing, or mobility functions. At least some of the network devices may include subcomponents such as an access network entity, which may be an example of an access node controller (ANC). Each access network entity may communicate with a number of UEs 115 through a number of other access network transmission entities, each of which may be an example of a smart radio head, or a transmission/reception point (TRP). In some configurations, various functions of each access network entity or base station 105 may be distributed across various network devices (e.g., radio heads and access network controllers) or consolidated into a single network device (e.g., a base station 105).

As shown, wireless communications system 100 may include base station 105-a and UEs 115-a and 115-b in communication with base station 105a. In one embodiment, the UE 115-a may be configured with a first configuration and UE 115-b may be configured with a second configuration different from the first configuration. In some embodiments, the first and second configurations may include versions of software, firmware, and/or hardware of UEs 115-a and 115-b. For example, UE 115-a may be configured with a first version of system software and UE 115-b may be configured with a second version of system software. Additionally, or alternatively, UE 115-a may be configured with a first version of a chipset and UE 115-b may be configured with a second version of a chipset, etc.

In some cases, the base station 105-a may implement delay tolerant barring. In some cases, UE 115-b may be configured for delay tolerant access with base station 105-a while UE 115-a may not be configured for delay tolerant access. In some cases, a configuration of base station 105-a may result in UE 115-a being barred from establishing a connection with base station 105-a due to UE 115-a not being configured for delay tolerant access. In some embodiments, the configuration of base station 105-a may result in UE 115-a being barred whether or not base station 105-a implement delay tolerant barring. Accordingly, in one embodiment, a flag may be added to a message from base station 105-a to signal whether an access barring bitmap and/or category only applies to UEs making connections requests configured for delay tolerant access. For example, base station 105-a may indicate that delay tolerant barring applies to UEs of a second configuration (e.g., UE 115-b), but does not apply to UEs of a first configuration (e.g., UE 115-a). In some cases, base station 105-a may send an additional access barring bitmap to UEs 115-a and 115-b to prevent UE 115-a being barred even when the base station 105-a is not implementing barring procedures.

Wireless communications system 100 may operate in an ultra high frequency (UHF) frequency region using frequency bands from 700 MHz to 2600 MHz (2.6 GHz), although in some cases WLAN networks may use frequencies as high as 4 GHz. This region may also be known as the decimeter band, since the wavelengths range from approximately one decimeter to one meter in length. UHF waves may propagate mainly by line of sight, and may be blocked by buildings and environmental features. However, the waves may penetrate walls sufficiently to provide service to UEs 115 located indoors. Transmission of UHF waves is characterized by smaller antennas and shorter range (e.g., less than 100 km) compared to transmission using the smaller frequencies (and longer waves) of the high frequency (HF) or very high frequency (VHF) portion of the spectrum. In some cases, wireless communications system 100 may also utilize extremely high frequency (EHF) portions of the spectrum (e.g., from 30 GHz to 300 GHz). This region may also be known as the millimeter band, since the wavelengths range from approximately one millimeter to one centimeter in length. Thus, EHF antennas may be even smaller and more closely spaced than UHF antennas. In some cases, this may facilitate use of antenna arrays within a UE 115 (e.g., for directional beamforming). However, EHF transmissions may be subject to even greater atmospheric attenuation and shorter range than UHF transmissions.

Thus, wireless communications system 100 may support millimeter wave (mmW) communications between UEs 115 and base stations 105. Devices operating in mmW or EHF bands may have multiple antennas to allow beamforming. That is, a base station 105 may use multiple antennas or antenna arrays to conduct beamforming operations for directional communications with a UE 115. Beamforming (which may also be referred to as spatial filtering or directional transmission) is a signal processing technique that may be used at a transmitter (e.g., a base station 115) to shape and/or steer an overall antenna beam in the direction of a target receiver (e.g., a UE 115). This may be achieved by combining elements in an antenna array in such a way that transmitted signals at particular angles experience constructive interference while others experience destructive interference.

Multiple-input multiple-output (MIMO) wireless systems use a transmission scheme between a transmitter (e.g., a base station) and a receiver (e.g., a UE), where both transmitter and receiver are equipped with multiple antennas. Some portions of wireless communications system 100 may use beamforming. For example, base station 105 may have an antenna array with a number of rows and columns of antenna ports that the base station 105 may use for beamforming in its communication with UE 115. Signals may be transmitted multiple times in different directions (e.g., each transmission may be beamformed differently). A mmW receiver (e.g., a UE 115) may try multiple beams (e.g., antenna subarrays) while receiving the synchronization signals.

In some cases, the antennas of a base station 105 or UE 115 may be located within one or more antenna arrays, which may support beamforming or MIMO operation. One or more base station antennas or antenna arrays may be collocated at an antenna assembly, such as an antenna tower. In some cases, antennas or antenna arrays associated with a base station 105 may be located in diverse geographic locations. A base station 105 may multiple use antennas or antenna arrays to conduct beamforming operations for directional communications with a UE 115.

In some cases, wireless communications system 100 may be a packet-based network that operate according to a layered protocol stack. In the user plane, communications at the bearer or Packet Data Convergence Protocol (PDCP) layer may be IP-based. A Radio Link Control (RLC) layer may in some cases perform packet segmentation and reassembly to communicate over logical channels. A Medium Access Control (MAC) layer may perform priority handling and multiplexing of logical channels into transport channels. The MAC layer may also use Hybrid ARQ (HARD) to provide retransmission at the MAC layer to improve link efficiency. In the control plane, the Radio Resource Control (RRC) protocol layer may provide establishment, configuration, and maintenance of an RRC connection between a UE 115 and a network device 105-c, network device 105-b, or core network 130 supporting radio bearers for user plane data. At the Physical (PHY) layer, transport channels may be mapped to physical channels.

Time intervals in LTE or NR may be expressed in multiples of a basic time unit (which may be a sampling period of Tₛ=1/30,720,000 seconds). Time resources may be organized according to radio frames of length of 10 ms (T_{f}=307200T,), which may be identified by a system frame number (SFN) ranging from 0 to 1023. Each frame may include ten 1 ms subframes numbered from 0 to 9. A subframe may be further divided into two 0.5 ms slots, each of which contains 6 or 7 modulation symbol periods (depending on the length of the cyclic prefix prepended to each symbol). Excluding the cyclic prefix, each symbol contains 2048 sample periods. In some cases the subframe may be the smallest scheduling unit, also known as a TTI. In other cases, a TTI may be shorter than a subframe or may be dynamically selected (e.g., in short TTI bursts or in selected component carriers using short TTIs).

A resource element may consist of one symbol period and one subcarrier (e.g., a 15 KHz frequency range). A resource block may contain 12 consecutive subcarriers in the frequency domain and, for a normal cyclic prefix in each OFDM symbol, 7 consecutive OFDM symbols in the time domain (1 slot), or 84 resource elements. The number of bits carried by each resource element may depend on the modulation scheme (the configuration of symbols that may be selected during each symbol period). Thus, the more resource blocks that a UE receives and the higher the modulation scheme, the higher the data rate may be.

Wireless communications system 100 may support operation on multiple cells or carriers, a feature which may be referred to as carrier aggregation (CA) or multi-carrier operation. A carrier may also be referred to as a component carrier (CC), a layer, a channel, etc. The terms “carrier,” “component carrier,” “cell,” and “channel” may be used interchangeably herein. A UE 115 may be configured with multiple downlink CCs and one or more uplink CCs for carrier aggregation. Carrier aggregation may be used with both FDD and TDD component carriers.

In some cases, wireless communications system 100 may utilize enhanced component carriers (eCCs). An eCC may be characterized by one or more features including: wider bandwidth, shorter symbol duration, shorter transmission time interval (TTIs), and modified control channel configuration. In some cases, an eCC may be associated with a carrier aggregation configuration or a dual connectivity configuration (e.g., when multiple serving cells have a suboptimal or non-ideal backhaul link). An eCC may also be configured for use in unlicensed spectrum or shared spectrum (where more than one operator is allowed to use the spectrum). An eCC characterized by wide bandwidth may include one or more segments that may be utilized by UEs 115 that are not capable of monitoring the whole bandwidth or prefer to use a limited bandwidth (e.g., to conserve power).

In some cases, an eCC may utilize a different symbol duration than other CCs, which may include use of a reduced symbol duration as compared with symbol durations of the other CCs. A shorter symbol duration may be associated with increased subcarrier spacing. A TTI in an eCC may consist of one or multiple symbols. In some cases, the TTI duration (that is, the number of symbols in a TTI) may be variable. In some cases, an eCC may utilize a different symbol duration than other CCs, which may include use of a reduced symbol duration as compared with symbol durations of the other CCs. A shorter symbol duration is associated with increased subcarrier spacing. A device, such as a UE 115 or base station 105, utilizing eCCs may transmit wideband signals (e.g., 20, 40, 60, 80 Mhz, etc.) at reduced symbol durations (e.g., 16.67 microseconds). A TTI in eCC may consist of one or multiple symbols. In some cases, the TTI duration (that is, the number of symbols in a TTI) may be variable.

In some cases, wireless system 100 may utilize both licensed and unlicensed radio frequency spectrum bands. For example, wireless system 100 may employ LTE License Assisted Access (LTE-LAA) or LTE Unlicensed (LTE U) radio access technology or NR technology in an unlicensed band such as the 5 Ghz Industrial, Scientific, and Medical (ISM) band. When operating in unlicensed radio frequency spectrum bands, wireless devices such as base stations 105 and UEs 115 may employ listen-before-talk (LBT) procedures to ensure the channel is clear before transmitting data. In some cases, operations in unlicensed bands may be based on a carrier aggregation (CA) configuration in conjunction with component carriers (CCs) operating in a licensed band. Operations in unlicensed spectrum may include downlink transmissions, uplink transmissions, or both. Duplexing in unlicensed spectrum may be based on frequency division duplexing (FDD), time division duplexing (TDD) or a combination of both.

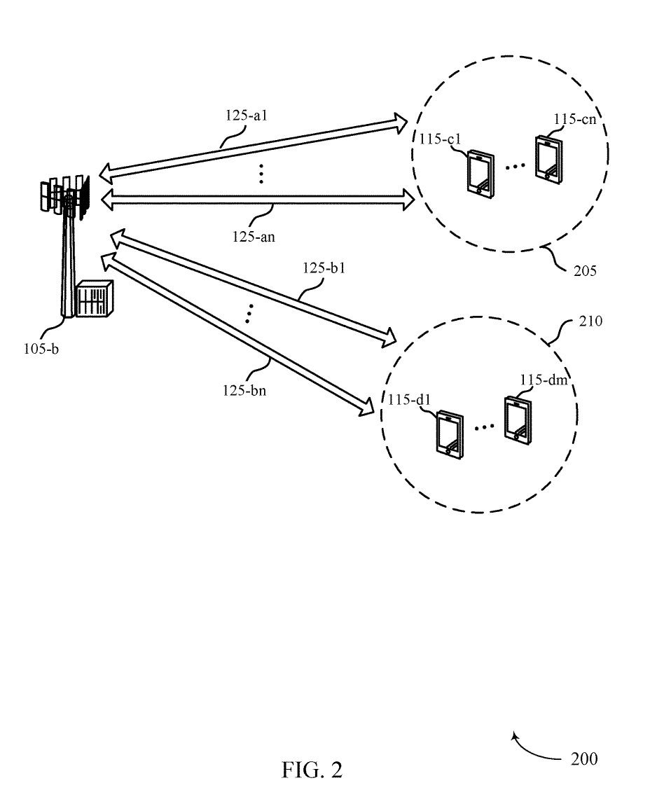

FIG. 2 illustrates an example of a wireless communications system 200 for signal barring of delay tolerant access in accordance with various aspects of the present disclosure. Wireless communications system 200 may include a first group of UEs 205, a second group of UEs 210, and base station 105-b, which may be examples of a UE 115 base station 105 described with reference to FIG. 1.

In one embodiment, the first group of UEs 205 may include one or more UEs of a first configuration. As shown, the first group of UEs 205 may include “n” UEs from UE 115-c1 to UE 115-cn. In some cases, the second group of UEs 210 may include one or more UEs of a second configuration. As shown, the second group of UEs 210 may include “m” UEs from UE 115-d1 to UE 115-dm.

In one embodiment, one or more UEs in the first group of UEs 205 may be configured to establish communication links with base station 105-b. Accordingly, UE 115-c1 may be configured to establish and/or request to establish communication link 125-a1 with base station 105-b. Likewise, UE 115-cn may be configured to establish and/or request to establish communication link 125-an with base station 105-i b.

In one embodiment, one or more UEs in the second group of UEs 210 may be configured to establish communication links with base station 105-b. Accordingly, UE 115-d1 may be configured to establish and/or request to establish communication link 125-b1 with base station 105-b. Likewise, UE 115-dn may be configured to establish and/or request to establish communication link 125-bn with base station 105-b.

In one embodiment, the UEs in the first group of UEs 205 may be configured with a first configuration and the UEs in the second group of UEs 210 may be configured with a second configuration different from the first configuration. In one embodiment, UEs in the first group of UEs 205 may request to establish a connection with base station 105-b in accordance with the first configuration of UEs in the first group of UEs 205, while UEs in the second group of UEs 210 may request to establish a connection with base station 105-b in accordance with the second configuration of UEs in the second group of UEs 210.

In some embodiments, base station 105-b may be configured to implement delay tolerant barring procedures to selectively bar certain UEs from establishing connections with base station 105-b. In some cases, UEs in the second group of UEs 210 may be configured for delay tolerant access with base station 205, whereas at least one of the UEs in the first group of UEs 205 may lack the configuration for delay tolerant access with base station 205. For example, when making connection requests with base station 105-b, UEs in the second group of UEs 210 may be configured to include a delayTolerantAccess establishment cause in the connection requests, while one or more UEs in the first group of UEs may not be configured to include a delayTolerantAccess establishment cause when making connection requests.

In some embodiments, a configuration of base station 105-b and/or a configuration of one or more UEs in the first group of UEs 205 may result in the barring of the one or more UEs in the first group of UEs 205 whether or not the delay tolerant barring procedures are implemented by base station 105-b. To prevent the barring of UEs in the first group of UEs 205 regardless of whether the delay tolerant barring procedures are implemented by base station 105-b, in some embodiments, base station 105-b may broadcast a message to the UEs of the first and second groups of UEs 205 and 210. In some cases, base station 105-b may broadcast to message to signal whether an access barring bitmap and/or category applies to UEs configured for requesting delay tolerant access connection requests with a delay tolerant access establishment cause. For example, base station 105-b may indicate with one or more bits in the message that access barring is enabled and that an access barring bitmap applies to UEs of the second group of UEs 210, but not the UEs of the first group of UEs 205. In some embodiments, an additional access barring bitmap may be sent to the UEs of the first and second group of UEs 205 and 210 to prevent UEs from the first group of UEs 205 from being barred even when the base station 105-b is not implementing barring procedures. For example, base station 105-b may send a first barring bitmap for the UEs of the first group of UEs 205 and send a second barring bitmap for the UEs of the second group of UEs 210. In some cases, when sending more than one bitmap, base station 105-b may send an indicator to instruct a UE which bitmap to apply.

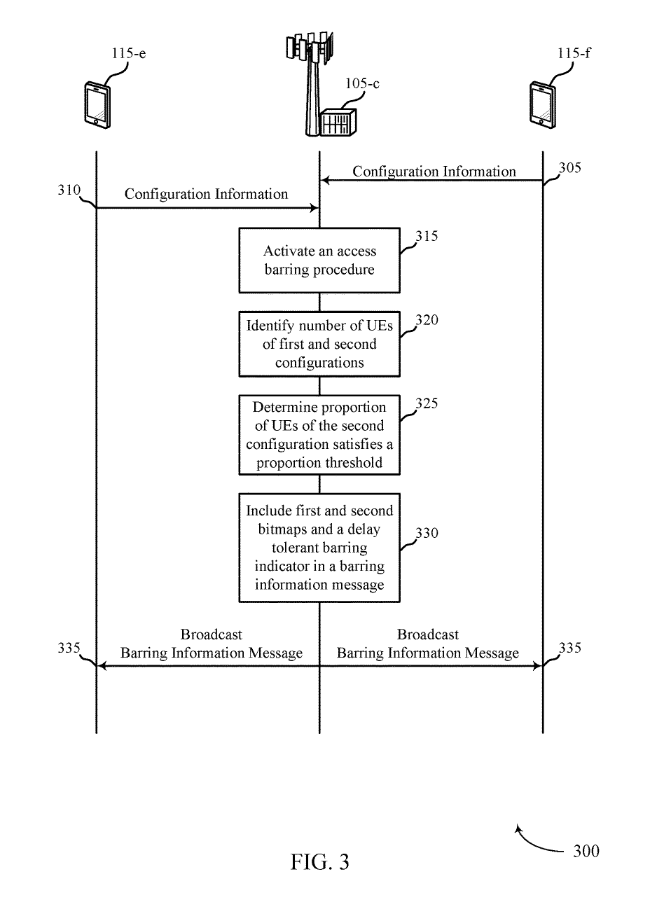

FIG. 3 illustrates an example of a process flow 300 for signal barring of delay tolerant access. Process flow 300 may include a UE 115-e, a UE 115-f, and base station 105-c, which may be examples of a UE 115 and base station 105 described with reference to FIGS. 1 and 2. UE 115-e may be configured with a first configuration and UE 115-f may be configured with a second configuration different from the first configuration. In some cases, base station 105-c may be configured to implement certain procedures that affects the ability of UE 115-e and/or UE 115-f to establish a connection with base station 105-c based on the respective configuration of UE 115-e and/or UE 115-f.

At 305, UE 115-f may send configuration information to base station 105-c relative to the second configuration of UE 115-f. At 310, UE 115-e may send configuration information to base station 105-c relative to the first configuration of UE 115-e. Although FIG. 3 depicts two UEs of first and second configurations sending configuration information to base station 105-c, it is understood that 305 may represent configuration information being sent from two or more UEs of the second configuration and that 310 may represent configuration information being sent from two or more UEs of the first configuration.

At 315, base station 105-c may activate an access barring procedure. For example, base station 105-c may implement access class baring (ACB). At 320, base station 105-c may identify the number of UEs of the first and second configurations that have established and/or are requesting to establish connections with base station 105-c. For example, base station 105-c may analyze the configuration information received at 305 and 310 to determine the number of UEs of the first and second configurations that have established and/or are requesting to establish connections with base station 105-c.

At 325, base station 105-c may determine a proportion of UEs of the second configuration relative to the total number of UEs that have established and/or are requesting to establish connections with base station 105-c. For example, base station 105-c may determine the total number of UEs that have established and/or are requesting to establish connections with base station 105-c and determine what proportion of this total are UEs of the second configuration. In one embodiment, the total number of UEs may include a total number UEs of the first and second configuration. In one embodiment, the total number of UEs may include a total number UEs of the first and second configuration as well as one or more other configurations different from the first and second configurations.

At block 330, base station 105-c may include at least one of a first barring bitmap, a second barring bitmap, and a delay tolerant barring indicator in a barring information message. At block 335, the base station 105-c may broadcast the barring information message to UEs 115-e and 115-f. In some embodiments, the barring information message may include a system information block (SIB) message.

In one embodiment, the first barring bitmap may be associated with UEs of a first configuration and the second barring bitmap may be associated with UEs of a second configuration. In some cases, base station 105-c may include in the barring information message first and second barring bitmaps and a delay tolerant barring indicator based at least in part on the determination of the proportion of UEs that are of the second configuration. For example, base station 105-c may determine how to configure, what to include, and/or what bits to set in the broadcast barring information message based on the proportion of UEs of the second configuration relative to the total number of UEs that have established and/or are requesting to establish connections with base station 105-c. As one example, base station 105-c may compare the proportion of UEs that are of the second configuration with a predetermined proportion threshold. In one embodiment, when the proportion of UEs that are of the second configuration satisfies the predetermined proportion threshold, the base station 105-c may include at least the second barring bitmap and the delay tolerant barring indicator in the barring information message.

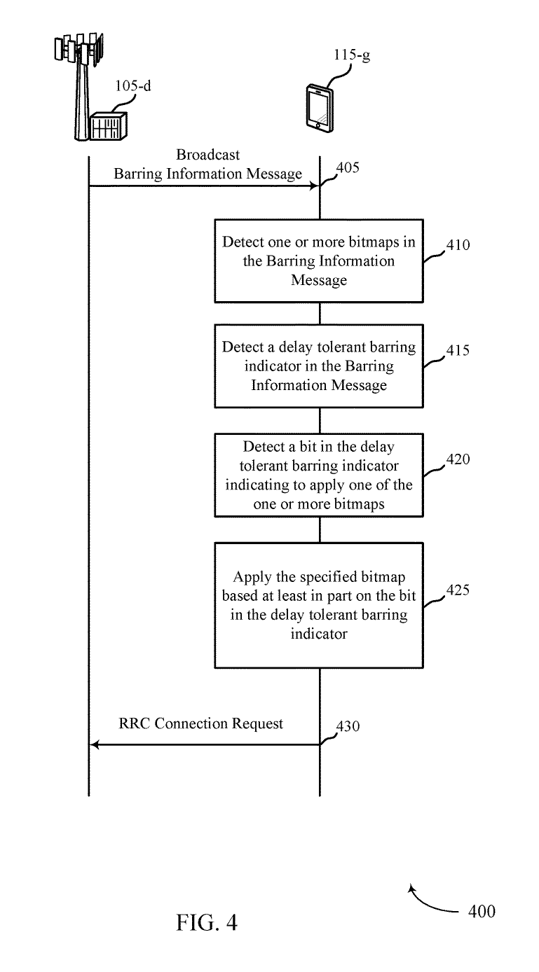

FIG. 4 illustrates an example of a process flow 400 for signal barring of delay tolerant access. Process flow 400 may include a UE 115-g and base station 105-d, which may be examples of a UE 115 and base station 105 described with reference to FIGS. 1-3. UE 115-g may be configured with a first configuration or a second configuration different from the first configuration. In some cases, base station 105-d may be configured to implement certain procedures that affects the ability of UE 115-g to establish a connection with base station 105-d based on the configuration of UE 115-g.

At 405, base station 105-d may broadcast a barring information message to one or more UEs. For example, UE 115-g may receive the broadcasted barring information message, as illustrated. In some embodiments, base station 105-d may include at least one of a first barring bitmap, second barring bitmap, and a delay tolerant barring indicator in the barring information message.

At 410, UE 115-g may detect one or more bitmaps in the barring information message. For example, UE 115-g may detect that base station 105-d sends at least one of a first barring bitmap and a second barring bitmap in the barring information message. As explained above, the first barring bitmap may be associated with UEs of a first configuration and the second barring bitmap may be associated with UEs of a second configuration different from the first configuration.

At 415, UE 115-g may detect a delay tolerant barring indicator in the barring information message. At 420, UE 115-g may detect a setting of a bit in the delay tolerant barring indicator. In some embodiments, the bit may indicate whether to apply a first barring bitmap or a second barring bitmap sent in the barring information message. For example, base station 105-d may send a first barring bitmap and instruct, via the bit setting in the delay tolerant barring indicator, UE 115-g to apply the first barring bitmap. Likewise, base station 105-d may send a second barring bitmap and instruct, via the bit setting in the delay tolerant barring indicator, UE 115-g to apply the second barring bitmap. In some cases, base station 105-d may send a first barring bitmap as well as a second barring bitmap in the barring information message and instruct, via the bit setting in the delay tolerant barring indicator, UE 115-g to apply the first or the second barring bitmap.

At 425, UE 115-g may apply a particular bitmap included in the barring information message based at least in part on the setting of the bit in the delay tolerant barring indicator. At 430, UE 115-g may send a Radio Resource Control (RRC) connection request to base station 105-d in accordance with the UE 115-g applying the bitmap specified in the barring information message. In some cases, the specified bitmap may indicate whether UE 115-g is permitted to make the RRC connection request or not. In some cases, the barring information message may indicate a time period during which UE 115-g is barred from establishing a connection with base station 105-d.

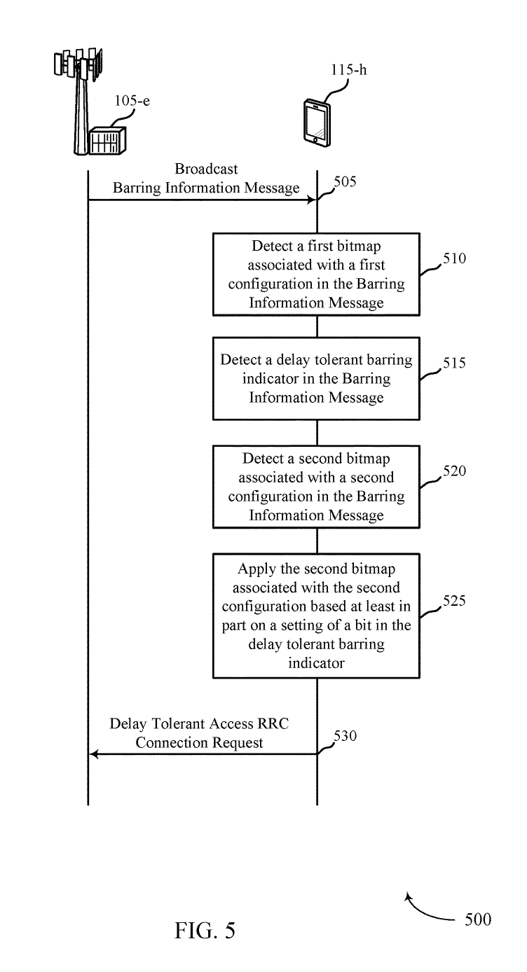

FIG. 5 illustrates an example of a process flow 500 for signal barring of delay tolerant access. Process flow 500 may include a UE 115-h and base station 105-e, which may be examples of a UE 115 and base station 105 described with reference to FIGS. 1-4. UE 115-h may be configured with a first configuration or a second configuration different from the first configuration. In some cases, base station 105-e may be configured to implement certain procedures that affects the ability of UE 115-h to establish a connection with base station 105-e based on the configuration of UE 115-h.

At 505, base station 105-e may broadcast a barring information message to one or more UEs. For example, UE 115-h may receive the broadcasted barring information message, as illustrated. At 510, UE 115-h may detect a first barring bitmap associated with a first configuration in the barring information message. At 515, UE 115-h may detect a delay tolerant barring indicator in the barring information message.

At 520, UE 115-h may detect a second barring bitmap associated with a second configuration in the barring information message. At 525, UE 115-h may apply the second barring bitmap associated with the second configuration based at least in part on the delay tolerant barring indicator indicating UE 115-h is to apply the second barring bitmap. For example, a setting of a bit of a field in the delay tolerant barring indicator may indicate the second barring bitmap is to be applied. At 530, UE 115-h may send an RRC connection request to base station 105-e. In some embodiments, UE 115-h may send a delay tolerant access RRC connection request to base station 105-e. For example, UE 115-h may include a delayTolerantAccess establishment cause in the RRC connection request at 530.

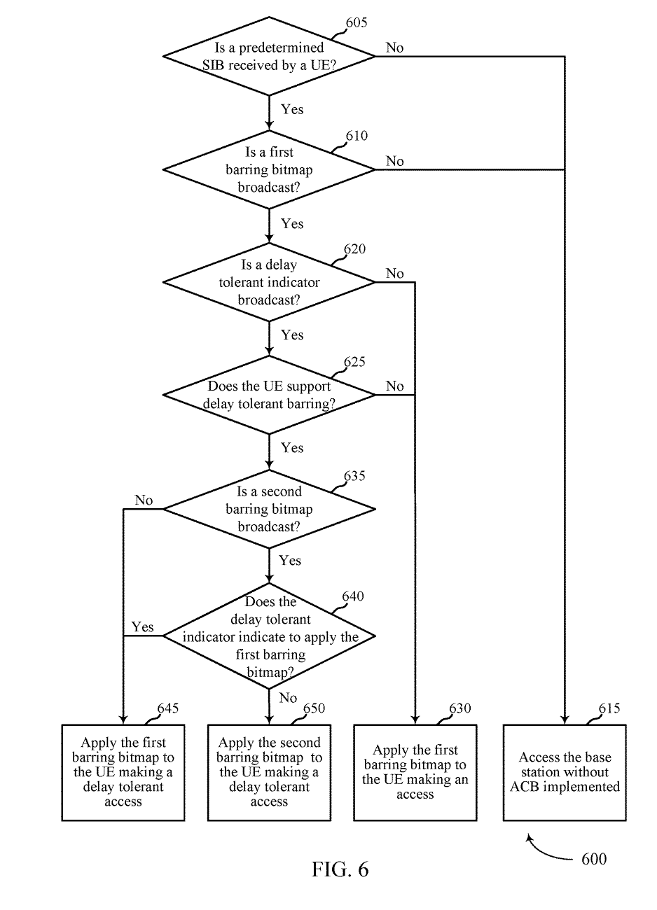

FIG. 6 illustrates an example of a method 600 for signal barring of delay tolerant access in accordance with various aspects of the present disclosure. The operations of method 900 may be performed in relation to a base station 105 and/or a UE 115 as described in at least one of FIGS. 1-5. In one embodiment, the operations of method 600 may be implemented by a UE 115 or its components as described herein. In some examples, a UE 115 may execute a set of codes to control the functional elements of the device to perform the functions described below. Additionally or alternatively, the UE 115 may perform aspects the functions described below using special-purpose hardware.

At block 905, the method 600 may include determining whether a system information block (SIB) message is received by a UE. For example, method 600 may include determining whether a base station broadcasts a SIB message to the UE. In some cases, method 600 may include determining whether the base station broadcasts a specific SIB message. For instance, method 600 may include determining whether the base station broadcasts SIB-14.

At block 910, when method 600 determines the predetermined SIB message is received by the UE, the method 600 may include determining whether a first barring bitmap is broadcasted. For example, method 600 may determine whether a barring information message, sent by a base station and received by the UE, includes a first barring bitmap associated with a first configuration of UEs. In some embodiments, upon determining the predetermined SIB message is received by the UE, the method 600 may include determining that the base station is implementing access barring.

At block 915, when method 600 determines the SIB message is not transmitted, method 600 may include permitting a UE to access a base station without ACB implemented. For example, upon determining the SIB message is not transmitted, method 600 may determine that the base station does not implement ACB. In some cases, a UE may implement a first connection request procedure when the base station implements ACB and may implement a second connection request procedure when the base station does not implement ACB. Accordingly, method 600 may instruct the UE to continue with the first connection request procedure upon determining the base station does not transmit the SIB message.

At block 920, when method 600 determines the first barring bitmap is broadcast, method 600 may include determining whether a delay tolerant indicator is broadcast. For example, method 600 may determine whether a barring information message, sent by a base station and received by a UE, includes a delay tolerant indicator.

At block 925, when method 600 determines a delay tolerant indicator is broadcast, method 600 may include determining whether the UE is configured to support delay tolerant barring. For example, when the UE is of a first configuration, method 600 may determine whether the first configuration supports delay tolerant barring. Likewise, when the UE is of a second configuration different from the first configuration, method 600 may determine whether the second configuration supports delay tolerant barring.

At block 930, when method 600 determines the UE does not support delay tolerant barring, method 600 may include applying the first barring bitmap to the UE based on the UE making a request for access. For instance, upon determining the UE is not configured to make delay tolerant connection requests, method 600 may include applying the first bitmap to the UE based at least in part on method 600 determining the UE is not configured to make delay tolerant access connection requests and determining at 605 that the base station is implementing access barring.

At block 935, when method 600 determines the UE does support delay tolerant barring, method 600 may include determining whether a second barring bitmap is broadcasted. For example, method 600 may determine whether a barring information message, sent by a base station and received by the UE, includes a second barring bitmap associated with a second configuration of UEs.

At block 940, when method 600 determines the second barring bitmap is being broadcasted, method 600 may include determining whether the delay tolerant indicator indicates to apply the first bitmap. In some cases, the delay tolerant indicator may indicate whether to apply the first barring bitmap or the second barring bitmap.

At block 945, when method 600 determines the delay tolerant indicator indicates to apply the first bitmap, method 600 may include applying the first barring bitmap to the UE. In some cases, method 600 may include applying the first barring bitmap to the UE based at least in part on method 600 determining the UE is configured to make delay tolerant access connection requests.

At block 950, when method 600 determines the delay tolerant indicator does not indicate to apply the first bitmap, method 600 may include applying the second barring bitmap to the UE. In some cases, method 600 may include applying the second barring bitmap to the UE based at least in part on method 600 determining the UE is configured to make delay tolerant access connection requests.

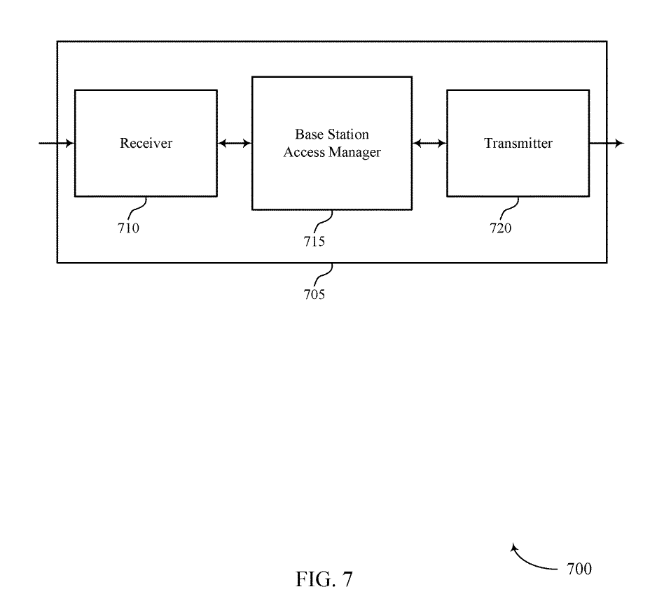

FIG. 7 shows a block diagram 700 of a wireless device 705 that supports signal barring of delay tolerant access in accordance with various aspects of the present disclosure. Wireless device 705 may be an example of aspects of a base station 105 as described with reference to FIG. 1. Wireless device 705 may include receiver 710, base station access manager 715, and transmitter 720. Wireless device 705 may also include a processor. Each of these components may be in communication with one another (e.g., via one or more buses).

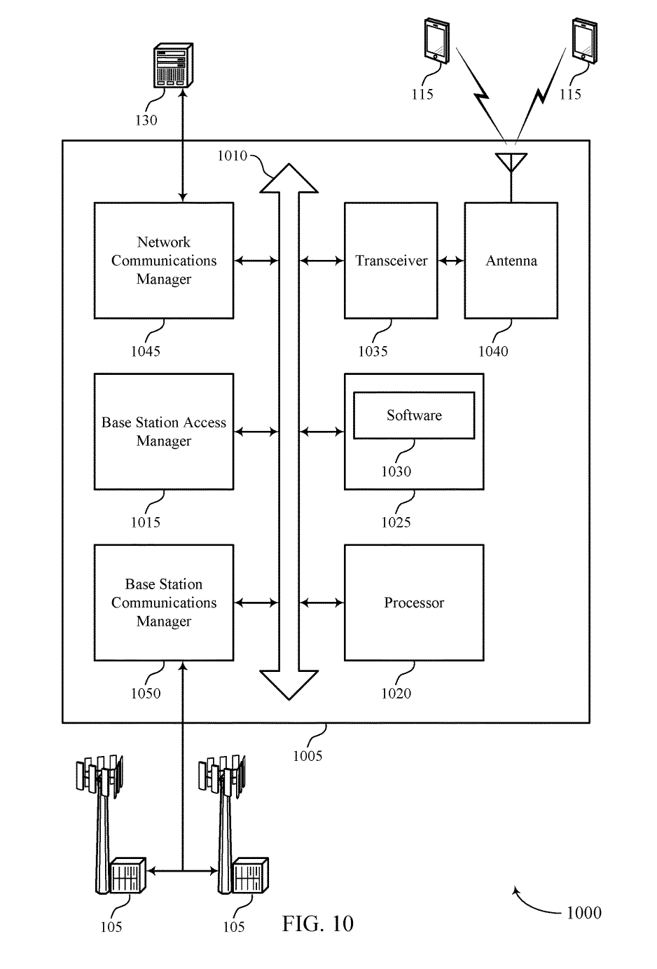

Receiver 710 may receive information such as packets, user data, or control information associated with various information channels (e.g., control channels, data channels, and information related to signal barring of delay tolerant access, etc.). Information may be passed on to other components of the device. The receiver 710 may be an example of aspects of the transceiver 1035 described with reference to FIG. 10.

Base station access manager 715 may be an example of aspects of the base station access manager 1015 described with reference to FIG. 10.

Base station access manager 715 may transmit a first barring bitmap associated with a first configuration of UEs based on a decision to implement ACB, determine a RAN provides network service to UEs of a second configuration, the second configuration being different from the first configuration, and transmit a delay tolerant barring indicator associated with the second configuration based on the decision to implement ACB and determining that the RAN provides network services to UEs of a second configuration.

Transmitter 720 may transmit signals generated by other components of the device. In some examples, the transmitter 720 may be collocated with a receiver 710 in a transceiver module. For example, the transmitter 720 may be an example of aspects of the transceiver 1035 described with reference to FIG. 10. The transmitter 720 may include a single antenna, or it may include a set of antennas.

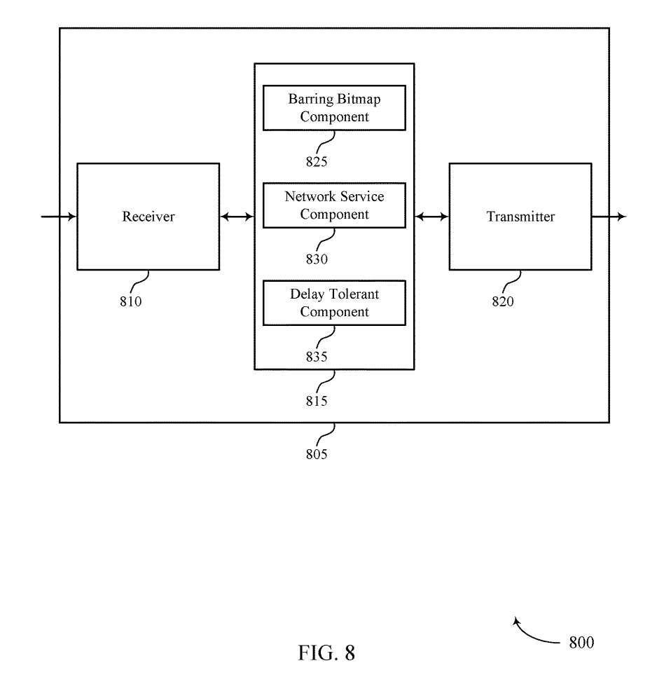

FIG. 8 shows a block diagram 800 of a wireless device 805 that supports signal barring of delay tolerant access in accordance with various aspects of the present disclosure. Wireless device 805 may be an example of aspects of a wireless device 705 or a base station 105 as described with reference to FIGS. 1-5 and 7. Wireless device 805 may include receiver 810, base station access manager 815, and transmitter 820. Wireless device 805 may also include a processor. Each of these components may be in communication with one another (e.g., via one or more buses).

Receiver 810 may receive information such as packets, user data, or control information associated with various information channels (e.g., control channels, data channels, and information related to signal barring of delay tolerant access, etc.). Information may be passed on to other components of the device. The receiver 810 may be an example of aspects of the transceiver 1035 described with reference to FIG. 10.

Base station access manager 815 may be an example of aspects of the base station access manager 1015 described with reference to FIG. 10. Base station access manager 815 may also include barring bitmap component 825, network service component 830, and delay tolerant component 835.

Barring bitmap component 825 may transmit a first barring bitmap associated with a first configuration of UEs based on a decision to implement ACB and transmit a second barring bitmap associated with the second configuration based on the determining. In some cases, the decision to implement ACB is based on network usage information associated with the RAN satisfies a congestion threshold. In some cases, the second barring bitmap associated with the second configuration indicates delay tolerant access classes of UEs are barred from accessing the RAN.

Network service component 830 may determine a RAN provides network service to UEs of a second configuration, the second configuration being different from the first configuration. In some cases, the network services provided by the RAN include a NB-IoT network service.

Delay tolerant component 835 may transmit a delay tolerant barring indicator associated with the second configuration based on the decision to implement ACB and determining that the RAN provides network services to UEs of a second configuration. In some cases, the delay tolerant barring indicator indicates whether to apply the first barring bitmap or a second barring bitmap associated with a second configuration. In some cases, the delay tolerant barring indicator includes a system information block (SIB).

Transmitter 820 may transmit signals generated by other components of the device. In some examples, the transmitter 820 may be collocated with a receiver 810 in a transceiver module. For example, the transmitter 820 may be an example of aspects of the transceiver 1035 described with reference to FIG. 10. The transmitter 820 may include a single antenna, or it may include a set of antennas.

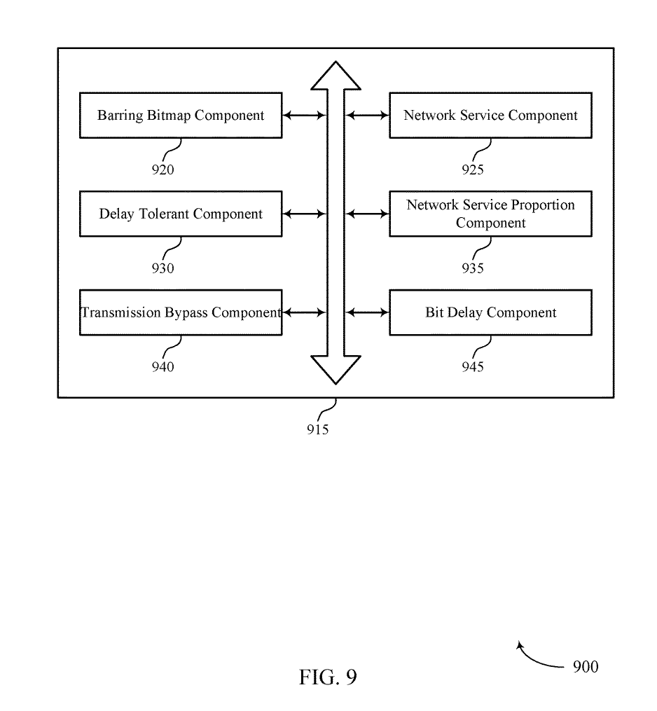

FIG. 9 shows a block diagram 900 of a base station access manager 915 that supports signal barring of delay tolerant access in accordance with various aspects of the present disclosure. The base station access manager 915 may be an example of aspects of a base station access manager 715, a base station access manager 815, or a base station access manager 1015 described with reference to FIGS. 7, 8, and 10. The base station access manager 915 may include barring bitmap component 920, network service component 925, delay tolerant component 930, network service proportion component 935, transmission bypass component 940, and bit delay component 945. Each of these modules may communicate, directly or indirectly, with one another (e.g., via one or more buses).

Barring bitmap component 920 may transmit a first barring bitmap associated with a first configuration of UEs based on a decision to implement ACB and transmit a second barring bitmap associated with the second configuration based on the determining. In some cases, the decision to implement ACB is based on network usage information associated with the RAN satisfies a congestion threshold. In some cases, the second barring bitmap associated with the second configuration indicates delay tolerant access classes of UEs are barred from accessing the RAN.

Network service component 925 may determine a RAN provides network service to UEs of a second configuration, the second configuration being different from the first configuration. In some cases, the network services provided by the RAN include a NB-IoT network service.

Delay tolerant component 930 may transmit a delay tolerant barring indicator associated with the second configuration based on the decision to implement ACB and determining that the RAN provides network services to UEs of a second configuration. In some cases, the delay tolerant barring indicator indicates whether to apply the first barring bitmap or a second barring bitmap associated with a second configuration. In some cases, the delay tolerant barring indicator includes a SIB.

Network service proportion component 935 may determine a proportion of the UEs of the second configuration, in relation to a total number of UEs that are provided network service by the RAN, satisfies a proportion threshold and determine a proportion of the UEs of the second configuration, in relation to a total number of UEs that are provided network service by the RAN, fails to satisfy a proportion threshold.

Transmission bypass component 940 may bypass a transmission of a second barring bitmap associated with the second configuration. Bit delay component 945 may set a bit of the delay tolerant indicator to indicate to UEs configured with the second configuration to apply the first barring bitmap based on determining the proportion of the UEs of the second configuration fails to satisfy the proportion threshold.

FIG. 10 shows a diagram of a system 1000 including a device 1005 that supports signal barring of delay tolerant access in accordance with various aspects of the present disclosure. Device 1005 may be an example of or include the components of wireless device 705, wireless device 805, or a base station 105 as described above, e.g., with reference to FIGS. 1-5, 7 and 8. Device 1005 may include components for bi-directional voice and data communications including components for transmitting and receiving communications, including base station access manager 1015, processor 1020, memory 1025, software 1030, transceiver 1035, antenna 1040, network communications manager 1045, and base station communications manager 1050. These components may be in electronic communication via one or more busses (e.g., bus 1010). Device 1005 may communicate wirelessly with one or more UEs 115.

Processor 1020 may include an intelligent hardware device, (e.g., a general-purpose processor, a digital signal processor (DSP), a central processing unit (CPU), a microcontroller, an application-specific integrated circuit (ASIC), an field-programmable gate array (FPGA), a programmable logic device, a discrete gate or transistor logic component, a discrete hardware component, or any combination thereof). In some cases, processor 1020 may be configured to operate a memory array using a memory controller. In other cases, a memory controller may be integrated into processor 1020. Processor 1020 may be configured to execute computer-readable instructions stored in a memory to perform various functions (e.g., functions or tasks supporting signal barring of delay tolerant access).

Memory 1025 may include random access memory (RAM) and read only memory (ROM). The memory 1025 may store computer-readable, computer-executable software 1030 including instructions that, when executed, cause the processor to perform various functions described herein. In some cases, the memory 1025 may contain, among other things, a basic input/output system (BIOS) which may control basic hardware and/or software operation such as the interaction with peripheral components or devices.

Software 1030 may include code to implement aspects of the present disclosure, including code to support signal barring of delay tolerant access. Software 1030 may be stored in a non-transitory computer-readable medium such as system memory or other memory. In some cases, the software 1030 may not be directly executable by the processor but may cause a computer (e.g., when compiled and executed) to perform functions described herein.

Transceiver 1035 may communicate bi-directionally, via one or more antennas, wired, or wireless links as described above. For example, the transceiver 1035 may represent a wireless transceiver and may communicate bi-directionally with another wireless transceiver. The transceiver 1035 may also include a modem to modulate the packets and provide the modulated packets to the antennas for transmission, and to demodulate packets received from the antennas.

In some cases, the wireless device may include a single antenna 1040. However, in some cases the device may have more than one antenna 1040, which may be capable of concurrently transmitting or receiving multiple wireless transmissions.

Network communications manager 1045 may manage communications with the core network (e.g., via one or more wired backhaul links). For example, the network communications manager 1045 may manage the transfer of data communications for client devices, such as one or more UEs 115.

Base station communications manager 1050 may manage communications with other base station 105, and may include a controller or scheduler for controlling communications with UEs 115 in cooperation with other base stations 105. For example, the base station communications manager 1050 may coordinate scheduling for transmissions to UEs 115 for various interference mitigation techniques such as beamforming or joint transmission. In some examples, base station communications manager 1050 may provide an X2 interface within an Long Term Evolution (LTE)/LTE-A wireless communication network technology to provide communication between base stations 105.

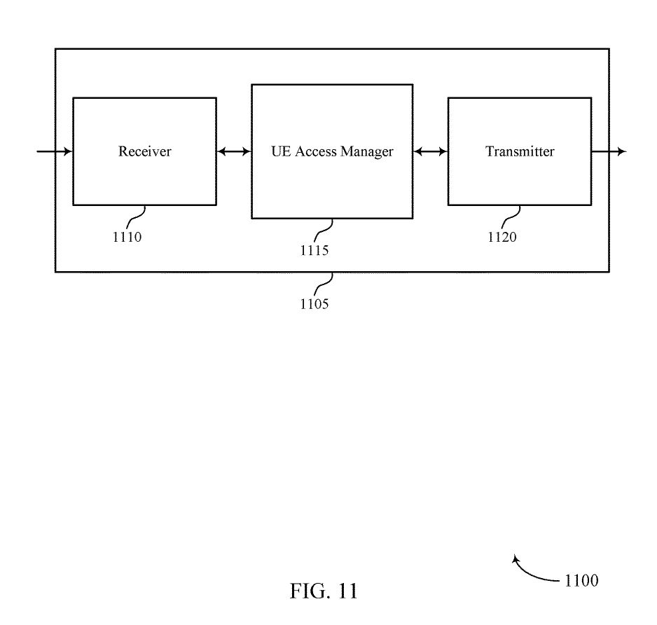

FIG. 11 shows a block diagram 1100 of a wireless device 1105 that supports signal barring of delay tolerant access in accordance with various aspects of the present disclosure. Wireless device 1105 may be an example of aspects of a UE 115 as described with reference to FIG. 1. Wireless device 1105 may include receiver 1110, UE access manager 1115, and transmitter 1120. Wireless device 1105 may also include a processor. Each of these components may be in communication with one another (e.g., via one or more buses).

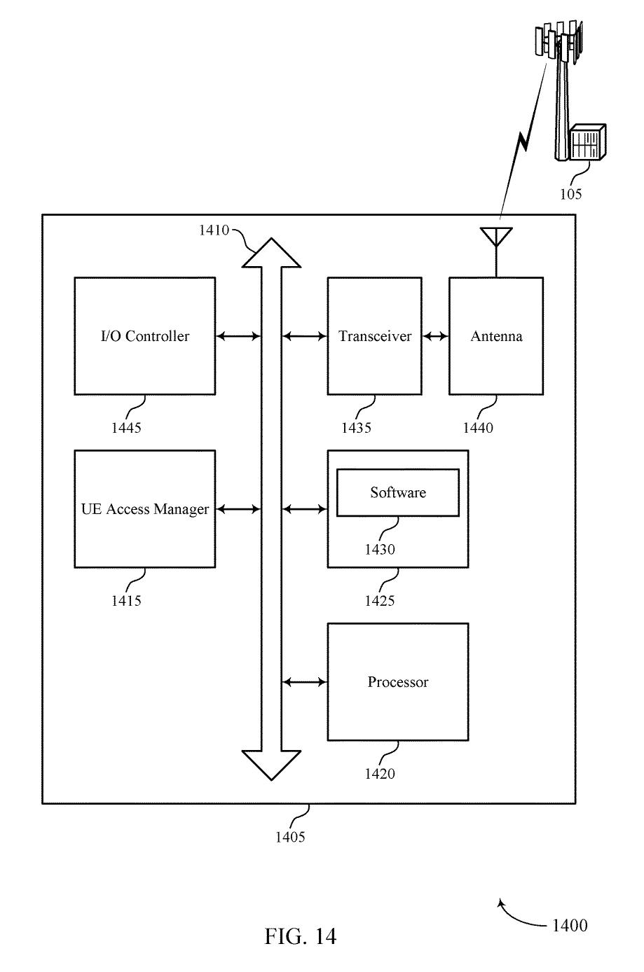

Receiver 1110 may receive information such as packets, user data, or control information associated with various information channels (e.g., control channels, data channels, and information related to signal barring of delay tolerant access, etc.). Information may be passed on to other components of the device. The receiver 1110 may be an example of aspects of the transceiver 1435 described with reference to FIG. 14. UE access manager 1115 may be an example of aspects of the UE access manager 1415 described with reference to FIG. 14.

UE access manager 1115 may receive, from a RAN, a first barring bitmap associated with a first configuration and receive, from the RAN, a delay tolerant barring indicator associated with a second configuration, the delay tolerant barring indicator triggering a decision as to whether the UE supports delay tolerant barring.

Transmitter 1120 may transmit signals generated by other components of the device. In some examples, the transmitter 1120 may be collocated with a receiver 1110 in a transceiver module. For example, the transmitter 1120 may be an example of aspects of the transceiver 1435 described with reference to FIG. 14. The transmitter 1120 may include a single antenna, or it may include a set of antennas.

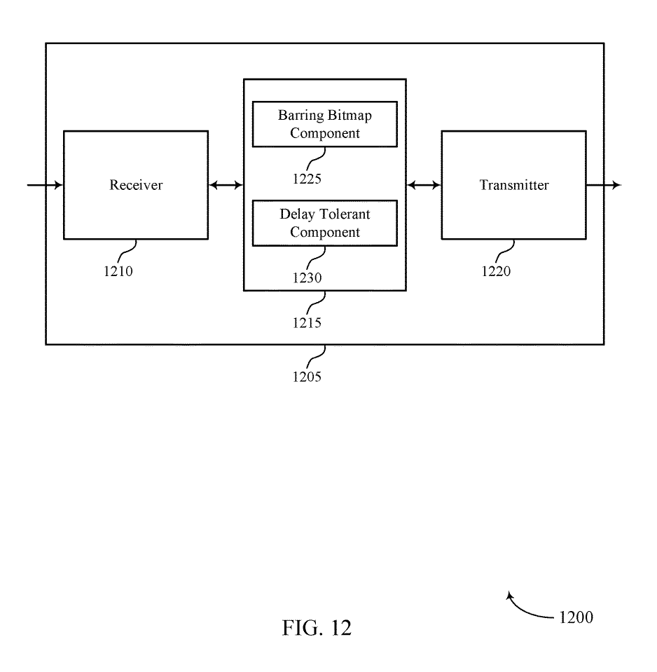

FIG. 12 shows a block diagram 1200 of a wireless device 1205 that supports signal barring of delay tolerant access in accordance with various aspects of the present disclosure. Wireless device 1205 may be an example of aspects of a wireless device 1105 or a UE 115 as described with reference to FIGS. 1 and 11. Wireless device 1205 may include receiver 1210, UE access manager 1215, and transmitter 1220. Wireless device 1205 may also include a processor. Each of these components may be in communication with one another (e.g., via one or more buses).

Receiver 1210 may receive information such as packets, user data, or control information associated with various information channels (e.g., control channels, data channels, and information related to signal barring of delay tolerant access, etc.). Information may be passed on to other components of the device. The receiver 1210 may be an example of aspects of the transceiver 1435 described with reference to FIG. 14.

UE access manager 1215 may be an example of aspects of the UE access manager 1415 described with reference to FIG. 14. UE access manager 1215 may also include barring bitmap component 1225 and delay tolerant component 1230.

Barring bitmap component 1225 may receive, from a RAN, a first barring bitmap associated with a first configuration and receive a second barring bitmap associated with the second configuration.

Delay tolerant component 1230 may receive, from the RAN, a delay tolerant barring indicator associated with a second configuration, the delay tolerant barring indicator triggering a decision as to whether the UE supports delay tolerant barring. In some cases, the delay tolerant barring indicator includes a SIB. In some cases, the UE is configured with at least one of the first configuration or the second configuration.

Transmitter 1220 may transmit signals generated by other components of the device. In some examples, the transmitter 1220 may be collocated with a receiver 1210 in a transceiver module. For example, the transmitter 1220 may be an example of aspects of the transceiver 1435 described with reference to FIG. 14. The transmitter 1220 may include a single antenna, or it may include a set of antennas.

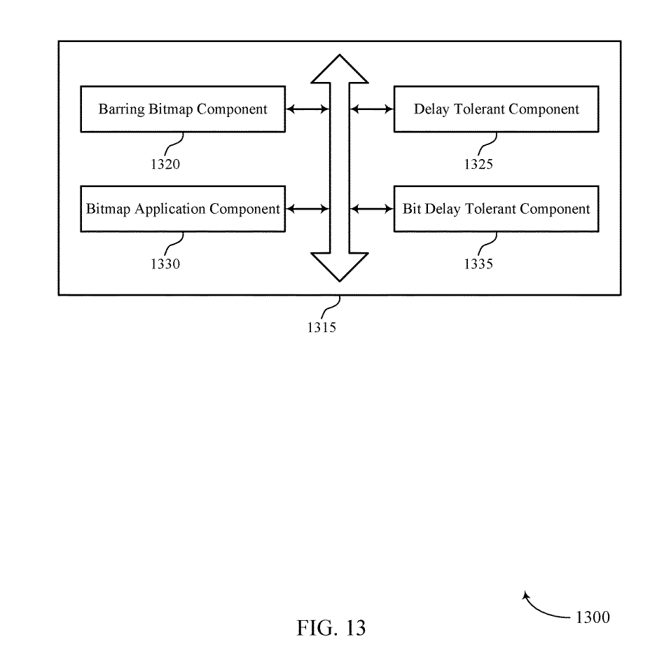

FIG. 13 shows a block diagram 1300 of a UE access manager 1315 that supports signal barring of delay tolerant access in accordance with various aspects of the present disclosure. The UE access manager 1315 may be an example of aspects of a UE access manager 1415 described with reference to FIGS. 11, 12, and 14. The UE access manager 1315 may include barring bitmap component 1320, delay tolerant component 1325, bitmap application component 1330, and bit delay tolerant component 1335. Each of these modules may communicate, directly or indirectly, with one another (e.g., via one or more buses).

Barring bitmap component 1320 may receive, from a RAN, a first barring bitmap associated with a first configuration and receive a second barring bitmap associated with the second configuration.

Delay tolerant component 1325 may receive, from the RAN, a delay tolerant barring indicator associated with a second configuration, the delay tolerant barring indicator triggering a decision as to whether the UE supports delay tolerant barring. In some cases, the delay tolerant barring indicator includes a SIB. In some cases, the UE is configured with at least one of the first configuration or the second configuration.

Bitmap application component 1330 may apply the second barring bitmap with respect to accessing the RAN based on the decision that the UE supports delay tolerant barring, apply the first barring bitmap with respect to accessing the RAN based on the identified bit of the delay tolerant barring indicator being enabled, apply the first barring bitmap to the UE with respect to accessing the RAN, and apply the first barring bitmap with respect to accessing the RAN based on the decision that the UE fails to support delay tolerant barring. Bit delay tolerant component 1335 may identify a bit of the delay tolerant barring indicator is enabled, the bit relating to applying the first barring bitmap.

FIG. 14 shows a diagram of a system 1400 including a device 1405 that supports signal barring of delay tolerant access in accordance with various aspects of the present disclosure. Device 1405 may be an example of or include the components of UE 115 as described above, e.g., with reference to FIG. 1. Device 1405 may include components for bi-directional voice and data communications including components for transmitting and receiving communications, including UE access manager 1415, processor 1420, memory 1425, software 1430, transceiver 1435, antenna 1440, and I/O controller 1445. These components may be in electronic communication via one or more busses (e.g., bus 1410). Device 1405 may communicate wirelessly with one or more base stations 105.

Processor 1420 may include an intelligent hardware device, (e.g., a general-purpose processor, a DSP, a CPU, a microcontroller, an ASIC, an FPGA, a programmable logic device, a discrete gate or transistor logic component, a discrete hardware component, or any combination thereof). In some cases, processor 1420 may be configured to operate a memory array using a memory controller. In other cases, a memory controller may be integrated into processor 1420. Processor 1420 may be configured to execute computer-readable instructions stored in a memory to perform various functions (e.g., functions or tasks supporting signal barring of delay tolerant access).

Memory 1425 may include RAM and ROM. The memory 1425 may store computer-readable, computer-executable software 1430 including instructions that, when executed, cause the processor to perform various functions described herein. In some cases, the memory 1425 may contain, among other things, a BIOS which may control basic hardware and/or software operation such as the interaction with peripheral components or devices.

Software 1430 may include code to implement aspects of the present disclosure, including code to support signal barring of delay tolerant access. Software 1430 may be stored in a non-transitory computer-readable medium such as system memory or other memory. In some cases, the software 1430 may not be directly executable by the processor but may cause a computer (e.g., when compiled and executed) to perform functions described herein.

Transceiver 1435 may communicate bi-directionally, via one or more antennas, wired, or wireless links as described above. For example, the transceiver 1435 may represent a wireless transceiver and may communicate bi-directionally with another wireless transceiver. The transceiver 1435 may also include a modem to modulate the packets and provide the modulated packets to the antennas for transmission, and to demodulate packets received from the antennas.

In some cases, the wireless device may include a single antenna 1440. However, in some cases the device may have more than one antenna 1440, which may be capable of concurrently transmitting or receiving multiple wireless transmissions.

I/O controller 1445 may manage input and output signals for device 1405. I/O controller 1445 may also manage peripherals not integrated into device 1405. In some cases, I/O controller 1445 may represent a physical connection or port to an external peripheral. In some cases, I/O controller 1445 may utilize an operating system such as iOS®, ANDROID®, MS-DOS®, MS-WINDOWS®, OS/2®, UNIX®, LINUX®, or another known operating system.

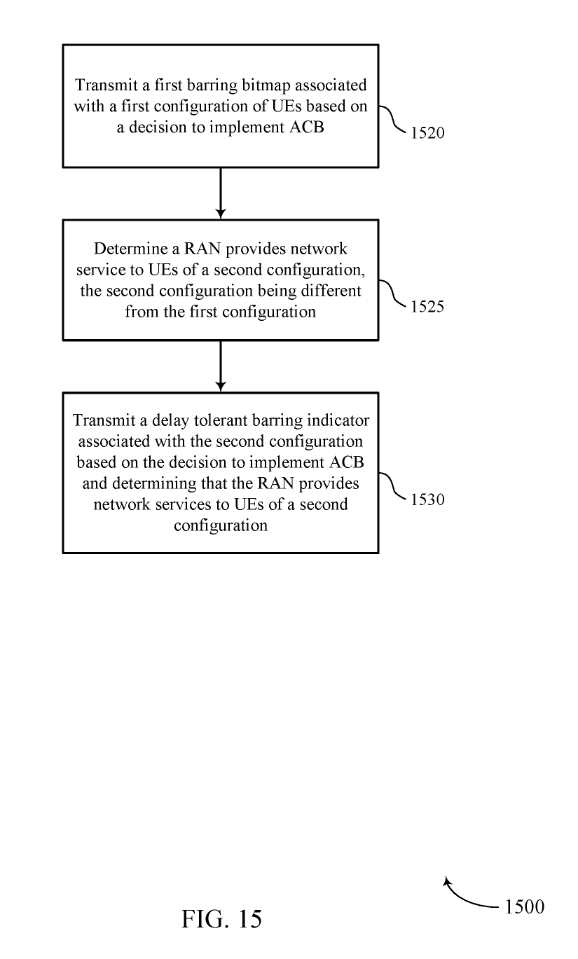

FIG. 15 shows a flowchart illustrating a method 1500 for signal barring of delay tolerant access in accordance with various aspects of the present disclosure. The operations of method 1500 may be implemented by a base station 105 or its components as described herein. For example, the operations of method 1500 may be performed by a base station access manager as described with reference to FIGS. 7 through 10. In some examples, a base station 105 may execute a set of codes to control the functional elements of the device to perform the functions described below. Additionally or alternatively, the base station 105 may perform aspects the functions described below using special-purpose hardware.

At block 1505 the base station 105 may transmit a first barring bitmap associated with a first configuration of UEs based at least in part on a decision to implement ACB. The operations of block 1505 may be performed according to the methods described with reference to FIGS. 1 through 6. In certain examples, aspects of the operations of block 1505 may be performed by a barring bitmap component as described with reference to FIGS. 7 through 10.

At block 1510 the base station 105 may determine a RAN provides network service to UEs of a second configuration, the second configuration being different from the first configuration. The operations of block 1510 may be performed according to the methods described with reference to FIGS. 1 through 6. In certain examples, aspects of the operations of block 1510 may be performed by a network service component as described with reference to FIGS. 7 through 10.

At block 1515 the base station 105 may transmit a delay tolerant barring indicator associated with the second configuration based at least in part on the decision to implement ACB and determining that the RAN provides network services to UEs of a second configuration. The operations of block 1515 may be performed according to the methods described with reference to FIGS. 1 through 6. In certain examples, aspects of the operations of block 1515 may be performed by a delay tolerant component as described with reference to FIGS. 7 through 10.

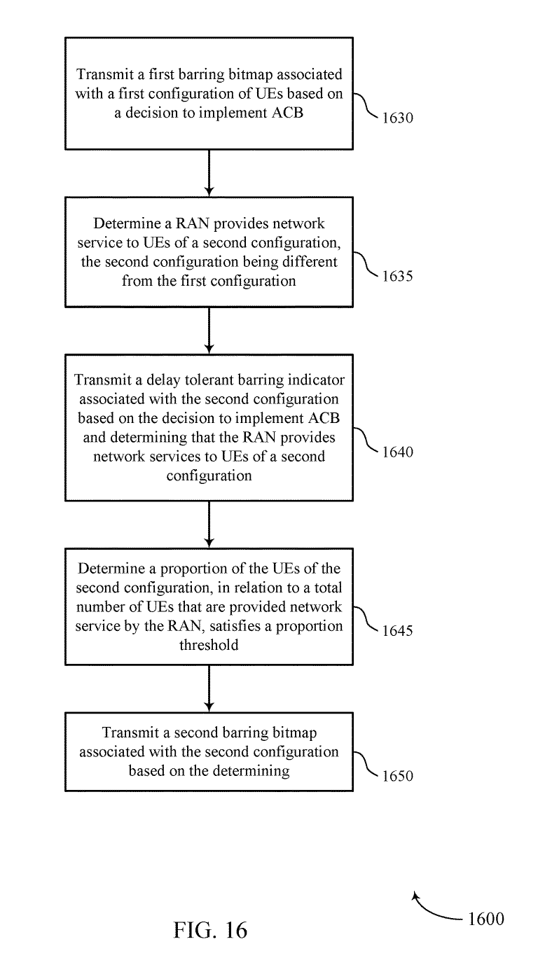

FIG. 16 shows a flowchart illustrating a method 1600 for signal barring of delay tolerant access in accordance with various aspects of the present disclosure. The operations of method 1600 may be implemented by a base station 105 or its components as described herein. For example, the operations of method 1600 may be performed by a base station access manager as described with reference to FIGS. 7 through 10. In some examples, a base station 105 may execute a set of codes to control the functional elements of the device to perform the functions described below. Additionally or alternatively, the base station 105 may perform aspects the functions described below using special-purpose hardware.

At block 1605 the base station 105 may transmit a first barring bitmap associated with a first configuration of UEs based at least in part on a decision to implement ACB. The operations of block 1605 may be performed according to the methods described with reference to FIGS. 1 through 6. In certain examples, aspects of the operations of block 1605 may be performed by a barring bitmap component as described with reference to FIGS. 7 through 10.

At block 1610 the base station 105 may determine a RAN provides network service to UEs of a second configuration, the second configuration being different from the first configuration. The operations of block 1610 may be performed according to the methods described with reference to FIGS. 1 through 6. In certain examples, aspects of the operations of block 1610 may be performed by a network service component as described with reference to FIGS. 7 through 10.

At block 1615 the base station 105 may transmit a delay tolerant barring indicator associated with the second configuration based at least in part on the decision to implement ACB and determining that the RAN provides network services to UEs of a second configuration. The operations of block 1615 may be performed according to the methods described with reference to FIGS. 1 through 6. In certain examples, aspects of the operations of block 1615 may be performed by a delay tolerant component as described with reference to FIGS. 7 through 10.

At block 1620 the base station 105 may determine a proportion of the UEs of the second configuration, in relation to a total number of UEs that are provided network service by the RAN, satisfies a proportion threshold. The operations of block 1620 may be performed according to the methods described with reference to FIGS. 1 through 6. In certain examples, aspects of the operations of block 1620 may be performed by a network service proportion component as described with reference to FIGS. 7 through 10.

At block 1625 the base station 105 may transmit a second barring bitmap associated with the second configuration based at least in part on the determining. The operations of block 1625 may be performed according to the methods described with reference to FIGS. 1 through 6. In certain examples, aspects of the operations of block 1625 may be performed by a barring bitmap component as described with reference to FIGS. 7 through 10.

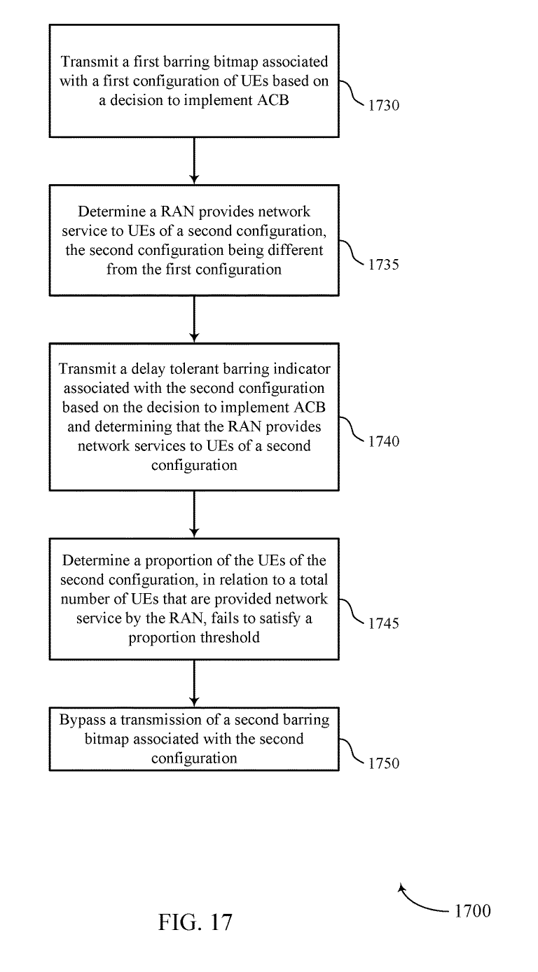

FIG. 17 shows a flowchart illustrating a method 1700 for signal barring of delay tolerant access in accordance with various aspects of the present disclosure. The operations of method 1700 may be implemented by a base station 105 or its components as described herein. For example, the operations of method 1700 may be performed by a base station access manager as described with reference to FIGS. 7 through 10. In some examples, a base station 105 may execute a set of codes to control the functional elements of the device to perform the functions described below. Additionally or alternatively, the base station 105 may perform aspects the functions described below using special-purpose hardware.

At block 1705 the base station 105 may transmit a first barring bitmap associated with a first configuration of UEs based at least in part on a decision to implement ACB. The operations of block 1705 may be performed according to the methods described with reference to FIGS. 1 through 6. In certain examples, aspects of the operations of block 1705 may be performed by a barring bitmap component as described with reference to FIGS. 7 through 10.

At block 1710 the base station 105 may determine a RAN provides network service to UEs of a second configuration, the second configuration being different from the first configuration. The operations of block 1710 may be performed according to the methods described with reference to FIGS. 1 through 6. In certain examples, aspects of the operations of block 1710 may be performed by a network service component as described with reference to FIGS. 7 through 10.

At block 1715 the base station 105 may transmit a delay tolerant barring indicator associated with the second configuration based at least in part on the decision to implement ACB and determining that the RAN provides network services to UEs of a second configuration. The operations of block 1715 may be performed according to the methods described with reference to FIGS. 1 through 6. In certain examples, aspects of the operations of block 1715 may be performed by a delay tolerant component as described with reference to FIGS. 7 through 10.

At block 1720 the base station 105 may determine a proportion of the UEs of the second configuration, in relation to a total number of UEs that are provided network service by the RAN, fails to satisfy a proportion threshold. The operations of block 1720 may be performed according to the methods described with reference to FIGS. 1 through 6. In certain examples, aspects of the operations of block 1720 may be performed by a network service proportion component as described with reference to FIGS. 7 through 10.

At block 1725 the base station 105 may bypass a transmission of a second barring bitmap associated with the second configuration. The operations of block 1725 may be performed according to the methods described with reference to FIGS. 1 through 6. In certain examples, aspects of the operations of block 1725 may be performed by a transmission bypass component as described with reference to FIGS. 7 through 10.

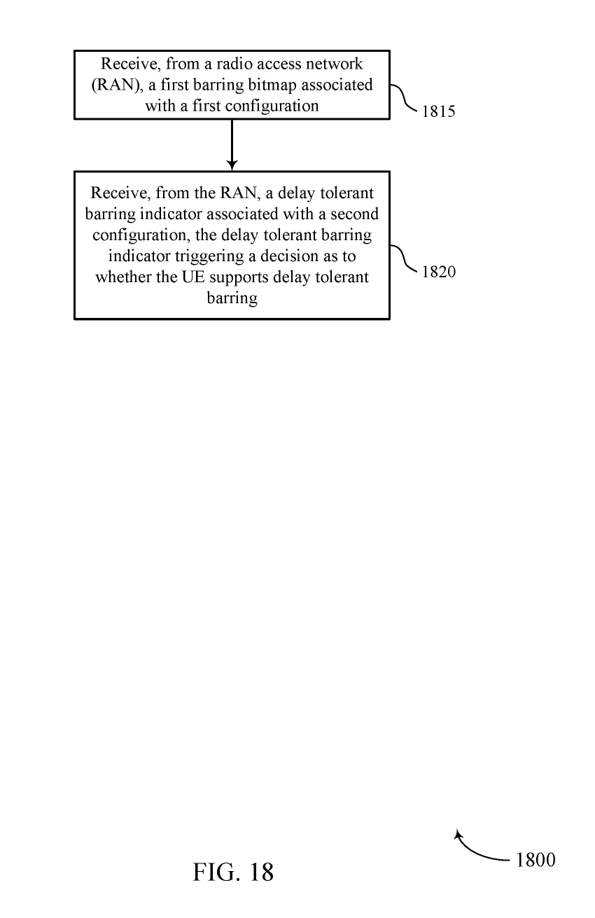

FIG. 18 shows a flowchart illustrating a method 1800 for signal barring of delay tolerant access in accordance with various aspects of the present disclosure. The operations of method 1800 may be implemented by a UE 115 or its components as described herein. For example, the operations of method 1800 may be performed by a UE access manager as described with reference to FIGS. 11 through 14. In some examples, a UE 115 may execute a set of codes to control the functional elements of the device to perform the functions described below. Additionally or alternatively, the UE 115 may perform aspects the functions described below using special-purpose hardware.

At block 1805 the UE 115 may receive, from a RAN, a first barring bitmap associated with a first configuration. The operations of block 1805 may be performed according to the methods described with reference to FIGS. 1 through 6. In certain examples, aspects of the operations of block 1805 may be performed by a barring bitmap component as described with reference to FIGS. 11 through 14.

At block 1810 the UE 115 may receive, from the RAN, a delay tolerant barring indicator associated with a second configuration, the delay tolerant barring indicator triggering a decision as to whether the UE supports delay tolerant barring. The operations of block 1810 may be performed according to the methods described with reference to FIGS. 1 through 6. In certain examples, aspects of the operations of block 1810 may be performed by a delay tolerant component as described with reference to FIGS. 11 through 14.

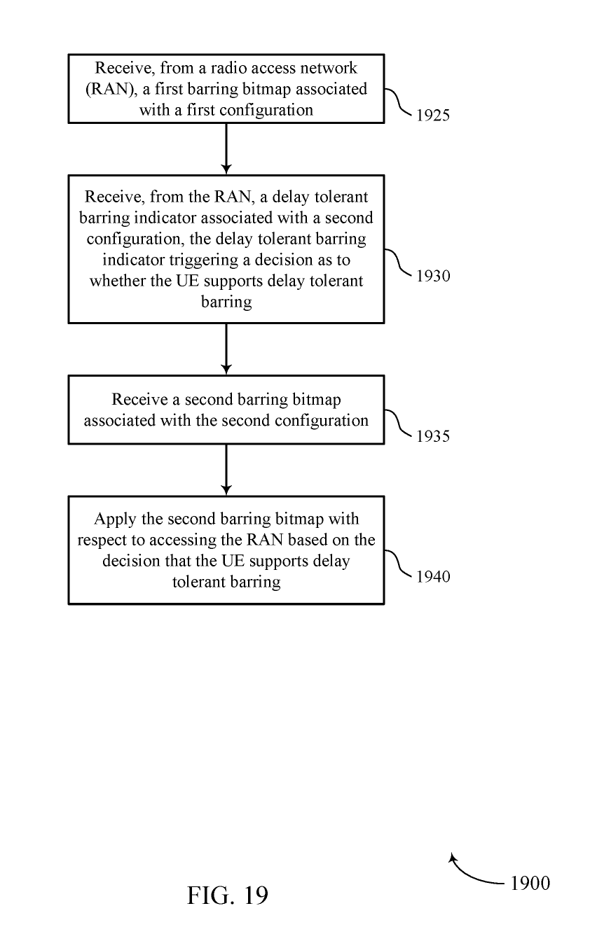

FIG. 19 shows a flowchart illustrating a method 1900 for signal barring of delay tolerant access in accordance with various aspects of the present disclosure. The operations of method 1900 may be implemented by a UE 115 or its components as described herein. For example, the operations of method 1900 may be performed by a UE access manager as described with reference to FIGS. 11 through 14. In some examples, a UE 115 may execute a set of codes to control the functional elements of the device to perform the functions described below. Additionally or alternatively, the UE 115 may perform aspects the functions described below using special-purpose hardware.

At block 1905 the UE 115 may receive, from a RAN, a first barring bitmap associated with a first configuration. The operations of block 1905 may be performed according to the methods described with reference to FIGS. 1 through 6. In certain examples, aspects of the operations of block 1905 may be performed by a barring bitmap component as described with reference to FIGS. 11 through 14.

At block 1910 the UE 115 may receive, from the RAN, a delay tolerant barring indicator associated with a second configuration, the delay tolerant barring indicator triggering a decision as to whether the UE supports delay tolerant barring. The operations of block 1910 may be performed according to the methods described with reference to FIGS. 1 through 6. In certain examples, aspects of the operations of block 1910 may be performed by a delay tolerant component as described with reference to FIGS. 11 through 14.

At block 1915 the UE 115 may receive a second barring bitmap associated with the second configuration. The operations of block 1915 may be performed according to the methods described with reference to FIGS. 1 through 6. In certain examples, aspects of the operations of block 1915 may be performed by a barring bitmap component as described with reference to FIGS. 11 through 14.

At block 1920 the UE 115 may apply the second barring bitmap with respect to accessing the RAN based at least in part on the decision that the UE supports delay tolerant barring. The operations of block 1920 may be performed according to the methods described with reference to FIGS. 1 through 6. In certain examples, aspects of the operations of block 1920 may be performed by a bitmap application component as described with reference to FIGS. 11 through 14.

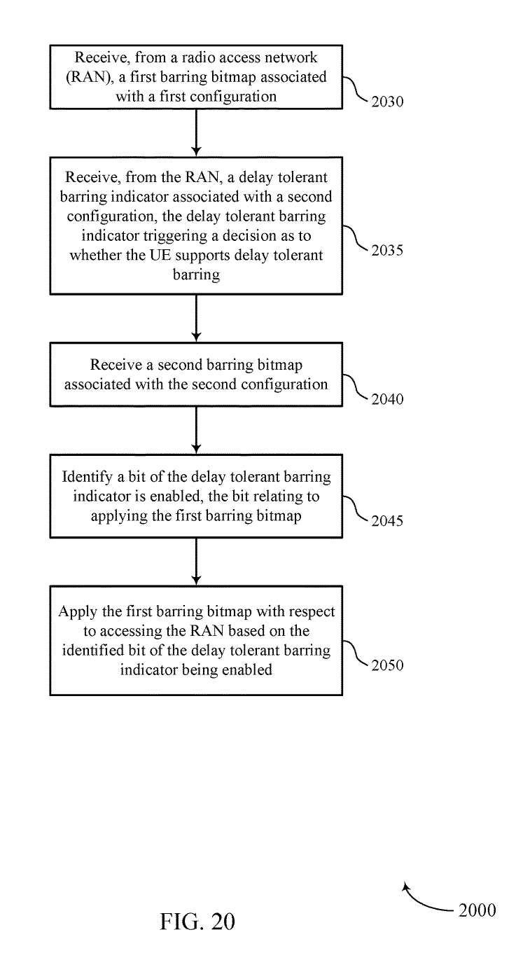

FIG. 20 shows a flowchart illustrating a method 2000 for signal barring of delay tolerant access in accordance with various aspects of the present disclosure. The operations of method 2000 may be implemented by a UE 115 or its components as described herein. For example, the operations of method 2000 may be performed by a UE access manager as described with reference to FIGS. 11 through 14. In some examples, a UE 115 may execute a set of codes to control the functional elements of the device to perform the functions described below. Additionally or alternatively, the UE 115 may perform aspects the functions described below using special-purpose hardware.

At block 2005 the UE 115 may receive, from a RAN, a first barring bitmap associated with a first configuration. The operations of block 2005 may be performed according to the methods described with reference to FIGS. 1 through 6. In certain examples, aspects of the operations of block 2005 may be performed by a barring bitmap component as described with reference to FIGS. 11 through 14.

At block 2010 the UE 115 may receive, from the RAN, a delay tolerant barring indicator associated with a second configuration, the delay tolerant barring indicator triggering a decision as to whether the UE supports delay tolerant barring. The operations of block 2010 may be performed according to the methods described with reference to FIGS. 1 through 6. In certain examples, aspects of the operations of block 2010 may be performed by a delay tolerant component as described with reference to FIGS. 11 through 14.

At block 2015 the UE 115 may receive a second barring bitmap associated with the second configuration. The operations of block 2015 may be performed according to the methods described with reference to FIGS. 1 through 6. In certain examples, aspects of the operations of block 2015 may be performed by a barring bitmap component as described with reference to FIGS. 11 through 14.

At block 2020 the UE 115 may identify a bit of the delay tolerant barring indicator is enabled, the bit relating to applying the first barring bitmap. The operations of block 2020 may be performed according to the methods described with reference to FIGS. 1 through 6. In certain examples, aspects of the operations of block 2020 may be performed by a bit delay tolerant component as described with reference to FIGS. 11 through 14.

At block 2025 the UE 115 may apply the first barring bitmap with respect to accessing the RAN based at least in part on the identified bit of the delay tolerant barring indicator being enabled. The operations of block 2025 may be performed according to the methods described with reference to FIGS. 1 through 6. In certain examples, aspects of the operations of block 2025 may be performed by a bitmap application component as described with reference to FIGS. 11 through 14.

It should be noted that the methods described above describe possible implementations, and that the operations and the steps may be rearranged or otherwise modified and that other implementations are possible. Furthermore, aspects from two or more of the methods may be combined.

Techniques described herein may be used for various wireless communications systems such as code division multiple access (CDMA), time division multiple access (TDMA), frequency division multiple access (FDMA), orthogonal frequency division multiple access (OFDMA), single carrier frequency division multiple access (SC-FDMA), and other systems. The terms “system” and “network” are often used interchangeably. A code division multiple access (CDMA) system may implement a radio technology such as CDMA2000, Universal Terrestrial Radio Access (UTRA), etc. CDMA2000 covers IS-2000, IS-95, and IS-856 standards. IS-2000 Releases may be commonly referred to as CDMA2000 1×, 1×, etc. IS-856 (TIA-856) is commonly referred to as CDMA2000 1×EV-DO, High Rate Packet Data (HRPD), etc. UTRA includes Wideband CDMA (WCDMA) and other variants of CDMA. A time division multiple access (TDMA) system may implement a radio technology such as Global System for Mobile Communications (GSM).

An orthogonal frequency division multiple access (OFDMA) system may implement a radio technology such as Ultra Mobile Broadband (UMB), Evolved UTRA (E-UTRA), Institute of Electrical and Electronics Engineers (IEEE) 802.11 (Wi-Fi), IEEE 802.16 (WiMAX), IEEE 802.20, Flash-OFDM, etc. UTRA and E-UTRA are part of Universal Mobile Telecommunications system (UMTS). 3GPP Long Term Evolution (LTE) and LTE-Advanced (LTE-A) are releases of Universal Mobile Telecommunications System (UMTS) that use E-UTRA. UTRA, E-UTRA, UMTS, LTE, LTE-A, NR, and Global System for Mobile communications (GSM) are described in documents from the organization named “3rd Generation Partnership Project” (3GPP). CDMA2000 and UMB are described in documents from an organization named “3rd Generation Partnership Project 2” (3GPP2). The techniques described herein may be used for the systems and radio technologies mentioned above as well as other systems and radio technologies. While aspects an LTE or an NR system may be described for purposes of example, and LTE or NR terminology may be used in much of the description, the techniques described herein are applicable beyond LTE or NR applications.

In LTE/LTE-A networks, including such networks described herein, the term evolved node B (eNB) may be generally used to describe the base stations. The wireless communications system or systems described herein may include a heterogeneous LTE/LTE-A or NR network in which different types of evolved node B (eNBs) provide coverage for various geographical regions. For example, each eNB, gNB or base station may provide communication coverage for a macro cell, a small cell, or other types of cell. The term “cell” may be used to describe a base station, a carrier or component carrier associated with a base station, or a coverage area (e.g., sector, etc.) of a carrier or base station, depending on context.

Base stations may include or may be referred to by those skilled in the art as a base transceiver station, a radio base station, an access point, a radio transceiver, a NodeB, eNodeB (eNB), next generation NodeB (gNB), Home NodeB, a Home eNodeB, or some other suitable terminology. The geographic coverage area for a base station may be divided into sectors making up only a portion of the coverage area. The wireless communications system or systems described herein may include base stations of different types (e.g., macro or small cell base stations). The UEs described herein may be able to communicate with various types of base stations and network equipment including macro eNBs, small cell eNBs, gNBs, relay base stations, and the like. There may be overlapping geographic coverage areas for different technologies.

A macro cell generally covers a relatively large geographic area (e.g., several kilometers in radius) and may allow unrestricted access by UEs with service subscriptions with the network provider. A small cell is a lower-powered base station, as compared with a macro cell, that may operate in the same or different (e.g., licensed, unlicensed, etc.) frequency bands as macro cells. Small cells may include pico cells, femto cells, and micro cells according to various examples. A pico cell, for example, may cover a small geographic area and may allow unrestricted access by UEs with service subscriptions with the network provider. A femto cell may also cover a small geographic area (e.g., a home) and may provide restricted access by UEs having an association with the femto cell (e.g., UEs in a closed subscriber group (CSG), UEs for users in the home, and the like). An eNB for a macro cell may be referred to as a macro eNB. An eNB for a small cell may be referred to as a small cell eNB, a pico eNB, a femto eNB, or a home eNB. An eNB may support one or multiple (e.g., two, three, four, and the like) cells (e.g., component carriers).

The wireless communications system or systems described herein may support synchronous or asynchronous operation. For synchronous operation, the base stations may have similar frame timing, and transmissions from different base stations may be approximately aligned in time. For asynchronous operation, the base stations may have different frame timing, and transmissions from different base stations may not be aligned in time. The techniques described herein may be used for either synchronous or asynchronous operations.

The downlink transmissions described herein may also be called forward link transmissions while the uplink transmissions may also be called reverse link transmissions. Each communication link described herein—including, for example, wireless communications system 100 and 200 of FIGS. 1 and 2—may include one or more carriers, where each carrier may be a signal made up of multiple sub-carriers (e.g., waveform signals of different frequencies).

The description set forth herein, in connection with the appended drawings, describes example configurations and does not represent all the examples that may be implemented or that are within the scope of the claims. The term “exemplary” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, well-known structures and devices are shown in block diagram form in order to avoid obscuring the concepts of the described examples.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label.

Information and signals described herein may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The various illustrative blocks and modules described in connection with the disclosure herein may be implemented or performed with a general-purpose processor, a DSP, an ASIC, an FPGA or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described above can be implemented using software executed by a processor, hardware, firmware, hardwiring, or combinations of any of these. Features implementing functions may also be physically located at various positions, including being distributed such that portions of functions are implemented at different physical locations. Also, as used herein, including in the claims, “or” as used in a list of items (for example, a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

Computer-readable media includes both non-transitory computer storage media and communication media including any medium that facilitates transfer of a computer program from one place to another. A non-transitory storage medium may be any available medium that can be accessed by a general purpose or special purpose computer. By way of example, and not limitation, non-transitory computer-readable media may comprise RAM, ROM, electrically erasable programmable read only memory (EEPROM), compact disk (CD) ROM or other optical disk storage, magnetic disk storage or other magnetic storage devices, or any other non-transitory medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, digital subscriber line (DSL), or wireless technologies such as infrared, radio, and microwave are included in the definition of medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

The description herein is provided to enable a person skilled in the art to make or use the disclosure. Various modifications to the disclosure will be readily apparent to those skilled in the art, and the generic principles defined herein may be applied to other variations without departing from the scope of the disclosure. Thus, the disclosure is not limited to the examples and designs described herein, but is to be accorded the broadest scope consistent with the principles and novel features disclosed herein.

What is claimed is:

1. A method for wireless communication, comprising:
transmitting a first barring bitmap associated with a first configuration of user equipments (UEs) based at least in part on a decision to implement access class barring (ACB);
determining a radio access network (RAN) provides network service to UEs of a second configuration, the second configuration being different from the first configuration; and
transmitting a delay tolerant barring indicator associated with the second configuration based at least in part on the decision to implement ACB and determining that the RAN provides network services to UEs of a second configuration.

2. The method of claim 1, wherein:
the delay tolerant barring indicator indicates whether to apply the first barring bitmap or a second barring bitmap to UEs configured with the second configuration.

3. The method of claim 1, further comprising:
determining a proportion of the UEs of the second configuration, in relation to a total number of UEs that are provided network service by the RAN, satisfies a proportion threshold.

4. The method of claim 3, further comprising:
transmitting a second barring bitmap associated with the second configuration based at least in part on the determining.

5. The method of claim 1, further comprising:
determining a proportion of the UEs of the second configuration, in relation to a total number of UEs that are provided network service by the RAN, fails to satisfy a proportion threshold.

6. The method of claim 5, further comprising:
bypassing a transmission of a second barring bitmap associated with the second configuration.

7. The method of claim 5, further comprising:
setting a bit of the delay tolerant indicator to indicate to UEs configured with the second configuration to apply the first barring bitmap based at least in part on determining the proportion of the UEs of the second configuration fails to satisfy the proportion threshold.

8. The method of claim 1, wherein:
the decision to implement ACB is based at least in part on network usage information associated with the RAN satisfies a congestion threshold.

9. The method of claim 1, wherein:
the second barring bitmap associated with the second configuration indicates delay tolerant access classes of UEs are barred from accessing the RAN.

10. The method of claim 1, wherein:
the network services provided by the RAN comprise a narrow band internet of things (NB-IoT) network service.

11. The method of claim 1, wherein:
the delay tolerant barring indicator comprises a system information block (SIB).

12. A method for wireless communication, comprising:
receiving, from a radio access network (RAN), a first barring bitmap associated with a first configuration; and
receiving, from the RAN, a delay tolerant barring indicator associated with a second configuration, the delay tolerant barring indicator triggering a decision as to whether the UE supports delay tolerant barring.

13. The method of claim 12, further comprising:
receiving a second barring bitmap associated with the second configuration.

14. The method of claim 13, further comprising:
applying the second barring bitmap with respect to accessing the RAN based at least in part on the decision that the UE supports delay tolerant barring.

15. The method of claim 13, further comprising:
identifying a bit of the delay tolerant barring indicator is enabled, the bit relating to applying the first barring bitmap; and
applying the first barring bitmap with respect to accessing the RAN based at least in part on the identified bit of the delay tolerant barring indicator being enabled.

16. The method of claim 13, further comprising:
applying the first barring bitmap to the UE with respect to accessing the RAN.

17. The method of claim 12, wherein:
the delay tolerant barring indicator comprises a system information block (SIB).

18. The method of claim 12, further comprising:
applying the first barring bitmap with respect to accessing the RAN based at least in part on the decision that the UE does not support delay tolerant barring.

19. The method of claim 12, wherein:
the UE is configured with at least one of the first configuration or the second configuration.

20. An apparatus for wireless communication, in a system comprising:
a processor;
memory in electronic communication with the processor; and
instructions stored in the memory and operable, when executed by the processor, to cause the apparatus to:
transmit a first barring bitmap associated with a first configuration of user equipments (UEs) based at least in part on a decision to implement access class barring (ACB);
determine a radio access network (RAN) provides network service to UEs of a second configuration, the second configuration being different from the first configuration; and
transmit a delay tolerant barring indicator associated with the second configuration based at least in part on the decision to implement ACB and determining that the RAN provides network services to UEs of a second configuration.

21. The apparatus of claim 20, wherein:
the delay tolerant barring indicator indicates whether to apply the first barring bitmap or a second barring bitmap associated with a second configuration.

22. The apparatus of claim 20, wherein the instructions are further executable by the processor to:
determine a proportion of the UEs of the second configuration, in relation to a total number of UEs that are provided network service by the RAN, satisfies a proportion threshold.

23. The apparatus of claim 22, wherein the instructions are further executable by the processor to:
transmit a second barring bitmap associated with the second configuration based at least in part on the determining.

24. The apparatus of claim 20, wherein the instructions are further executable by the processor to:
determine a proportion of the UEs of the second configuration, in relation to a total number of UEs that are provided network service by the RAN, fails to satisfy a proportion threshold.

25. The apparatus of claim 24, wherein the instructions are further executable by the processor to:
bypass a transmission of a second barring bitmap associated with the second configuration.

26. The apparatus of claim 24, wherein the instructions are further executable by the processor to:
set a bit of the delay tolerant indicator to indicate to UEs configured with the second configuration to apply the first barring bitmap based at least in part on determining the proportion of the UEs of the second configuration fails to satisfy the proportion threshold.

27. The apparatus of claim 20, wherein:
the decision to implement ACB is based at least in part on network usage information associated with the RAN satisfies a congestion threshold.

28. The apparatus of claim 20, wherein:
the second barring bitmap associated with the second configuration indicates delay tolerant access classes of UEs are barred from accessing the RAN.

29. The apparatus of claim 20, wherein:
the network services provided by the RAN comprise a narrow band internet of things (NB-IoT) network service.

30. An apparatus for wireless communication, in a system comprising:
a processor;
memory in electronic communication with the processor; and
instructions stored in the memory and operable, when executed by the processor, to cause the apparatus to:
receive, from a radio access network (RAN), a first barring bitmap associated with a first configuration; and
receive, from the RAN, a delay tolerant barring indicator associated with a second configuration, the delay tolerant barring indicator triggering a decision as to whether the UE supports delay tolerant barring.
